(19) United States
(12) Patent Application Publication
(10) Pub. No.: US 2022/0059071 A1
(43) Pub. Date: Feb. 24, 2022

(54) SOUND MODIFICATION OF SPEECH IN AUDIO SIGNALS OVER MACHINE COMMUNICATION CHANNELS

(71) Applicant: Intel Corporation, Santa Clara, CA (US)

(72) Inventors: David Pearce, El Dorado Hills, CA (US); Douglas Gabel, Hillsboro, OR (US); Kuba Lopatka, Poland (PL)

(21) Appl. No.: 17/518,376

(22) Filed: Nov. 3, 2021

(51) Int. Cl. G10L 13/033; G10L 13/047; G10L 13/08

(52) U.S. Cl. CPC G10L 13/033; G10L 13/08; G10L 13/047

(57) ABSTRACT

Apparatus, systems, articles of manufacture, and methods to modify sound of speech in an audio signal are disclosed. An example apparatus includes processor circuitry to execute instructions to: identify a first portion of a keyword in the speech of the audio signal during generation of the speech; determine a waveform to replace a second portion of the keyword; and transform the keyword into a different word by introducing the waveform into the audio signal.

### FIELD OF THE DISCLOSURE

This disclosure relates generally to audio signal analysis and, more particularly, to sound modification of speech in audio signals over machine communication channels.

### BACKGROUND

In some machine communication channels, such as in a gaming environment, some people use toxic or foul language. The toxic language may deter other people from participating in the gaming environment.

### BRIEF DESCRIPTION OF THE DRAWINGS

FIG. 1 is a block diagram of an example system for sound modification of speech in audio signals over machine communication channels in accordance with the teachings of this disclosure.

FIG. 2 is a block diagram of a first example sound analysis circuitry of FIG. 1.

FIG. 3 is a block diagram of a second example sound analysis circuitry of FIG. 1.

FIG. 4 is a block diagram of a third example sound analysis circuitry of FIG. 1.

FIG. 5 is a block diagram of a fourth example sound analysis circuitry of FIG. 1.

FIG. 6A is an example spectrogram of a first example word.

FIG. 6B is an example spectrogram of a second example word.

FIG. 6C is an example spectrogram including an example spectral mask.

FIGS. 7-11 are flowcharts representative of example machine readable instructions that may be executed by example processor circuitry to implement the example sound modification circuitry of FIG. 1 and the sound analysis circuitry of one or more of FIGS. 2-5.

FIG. 12 is a block diagram of an example processing platform including processor circuitry structured to execute the example machine readable instructions of FIGS. 7-11 to implement the example sound modification circuitry of FIG. 1.

FIG. 13 is a block diagram of an example implementation of the processor circuitry of FIG. 12.

FIG. 14 is a block diagram of another example implementation of the processor circuitry of FIG. 12.

FIG. 15 is a block diagram of an example software distribution platform (e.g., one or more servers) to distribute software (e.g., software corresponding to the example machine readable instructions of FIGS. 7-11) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

The figures are not to scale. Also, in general, the same reference numbers will be used throughout the drawing(s) and accompanying written description to refer to the same or like parts.

### DETAILED DESCRIPTION

Interactions between people over machine communication channels is common in many aspects of daily life including, for example, video conferencing, social interactions, gaming, etc. During some communications, people may use inappropriate or offensive language. For example, voice chat between players is a common part of networked gaming applications and often includes participants who are strangers to each other outside the gaming environment. Within this arena there is a risk of exposure to toxic speech (e.g., the use of foul language) from some other participants. In some instances, this risk is an issue that impacts the total addressable market for high value gaming systems and applications because some potential customers avoid participation and, therefore, avoid purchasing a gaming system or application to avoid exposure to the inappropriate language.

Automatic detection of the presence of toxic speech and filtering out the toxic speech may be used to remove the speech from an audio signal. However, in some examples, processing the audio signals for speech detection and filtering may introduce latency. In a real-time streaming speech communication channel, maintenance of low latency enables interactions to occur in a natural way. In addition, traditional mobile and VoIP systems (e.g., Skype, Zoom, Webex, etc.) have requirements that strictly limit the end-to-end latency.

One solution is to use a speech recognition (e.g., automatic speech recognition, ASR) system to transcribe the speech stream. As soon as a processor-based speech recognizer or decoder in the system outputs a toxic word, the speech stream can be muted or a beep inserted to cover the toxic word. Many processor-based recognizers will only produce output of each word after the word is spoken and usually with an additional delay after the end of each word for the recognizer to resolve the best word sequence in its search during the speech recognition process. If there is no additional delay inserted in the speech stream to the user, then the listening end would hear the toxic word before the mute or beep occurred. To prevent the passage of the toxic word, the speech stream can be delayed so that the toxicity detection can intervene before the toxic word is heard. For such a system, it is expected that the delay would typically need to be about the average duration of an average toxic word (estimated at 500 ms) plus the recognition decoder delay (estimate 200 ms). In this example, the inserted latency in the speech stream would be about 700 ms. However, this latency is not suitable for many applications. For example, voice communication over a VoIP service typically requires an end-to-end latency of <200 ms. For example, Skype certification specifies a receive path end-to-end latency of <140 ms with USB or embedded devices. Therefore, with this solution a choice has to be made: (1) have a latency that meets the requirement for VoIP latency for voice communication so that it is easy for users to talk to each other, but the first toxic word will be passed in the audio stream and heard by the listener before a mute or beep can be applied by the system, or (2) insert additional latency of about 700 ms in the speech stream so that the toxicity filter can block the toxic word from being heard but the latency is much higher than is tolerable for acceptable interactive voice chat.

Examples disclosed herein use a speech recognizer or a keyword spotter for detection of toxic words in an audio the stream as speech in the audio stream is being detected or generated. When a toxic word is detected, the second half or other latter portion(s) of the toxic word is modified in a delay buffer by replacing the signal for the latter part of the toxic word by the sounds of the latter part of a non-toxic, innocent, or benign word. For example, if a speech recognizer identifies that a person said a toxic word such as “fuck,” the latter part of the word would be changed so that the audio stream sounds as if the person said a non-toxic word (e.g., “fudge”). Latency in this example is reduced by the length of the first parts of the words that are modified because there is no need to wait for the latter part of the word.

Other examples disclosed herein use spectral masking with a predictive neural network. For example, an initial part of a word in a speech stream is used to predict a mask that would conceal or suppress the sound of a possible toxic word from being heard. If the person actually said a benign word instead, the benign word would be heard because the spectrum of the benign word is different from the mask. However, if the toxic word is spoken, the spectrum of the toxic word is suppressed by the mask. Thus, the neural network suppresses the sounds if the user were to speak a foul or toxic word but allows inoffensive speech through. In some examples, machine learning implemented by the neural network continuously updates the mask for a particular voice. Latency in this example is reduced further because, with predicative suppression, there is no reliance on waiting to detect an end of a keyword.

As used herein, a “toxic” word is broadly construed as any sort of foul, coarse, offensive, inappropriate, vulgar, profane, swear, or curse word. In addition, the examples disclosed herein may be used to modify sounds of other words including for example, words that may be confidential. For example, speakers in a conference without a non-disclosure agreement may have words suppressed or masked to protect confidentiality. In other examples, the words to be modified may include trade secret information and/or unregistered trademarks that are to be held in confidence. In other examples, the words to be modified may be names of people that are to be protected for privacy. Thus, throughout this disclosure and claims, a word to be modified that includes any of these examples or other words to be modified will be referred to as a “keyword.”

As used herein, “stream” and “signal” may be used interchangeably. An audio stream or audio signal is a continuous series of data representing a sound. The data may include multiple frames. Frames of different lengths have different durations of time.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” refer to dimensions that may not be exact due to manufacturing tolerances and/or other real world imperfections.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

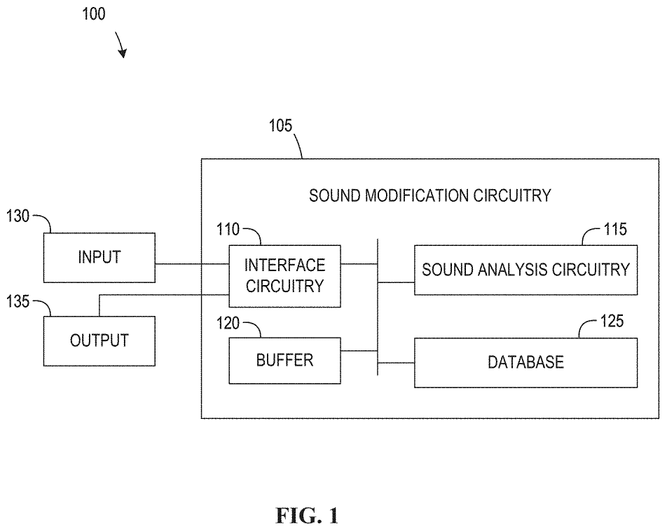

FIG. 1 is a block diagram of an example system 100 for sound modification of speech in audio signals including, for example, modification of one or more keywords over machine communication channels in accordance with the teachings of this disclosure. The example system 100 includes example sound modification circuitry 105. The sound modification circuitry 105 includes example interface circuitry 110, sound analysis circuitry 115, an example buffer 120, and an example database 125. The system 100 also includes an example input 130 and an example output 135.

The example sound modification circuitry 105 can modify sounds such as, for example, speech, in an audio signal as the speech is detected and/or generated. In some examples, the interface circuitry obtains, receives, and/or accesses an audio signal. In some examples, the audio signal is input to the sound modification circuitry 105 via the input 130. In some examples, the input 130 includes one or more microphones. In some examples, the input 130 is remote to the sound modification circuitry 105. For example, the sound modification circuitry 105 is be included in an apparatus with a first user, and the input 130 is included in an apparatus with a second user. In this example, the sound modification circuitry 105 modifies sounds (e.g., word(s)) in an audio signal generated by the second user before presentation of the audio signal to the first user. In other examples, the sound modification circuitry 105 is be included in an apparatus with the first user, and the input 130 also is included in the apparatus with the first user. In this example, the sound modification circuitry 105 modifies sounds (e.g., word(s)) in an audio signal generated by the first user before output from the first user's device for presentation to another user.

The sound analysis circuitry 115 analyzes the audio signal. The sound analysis circuitry 115 identifies a word or a portion of a word of speech in the audio signal. In some examples, the sound analysis circuitry 115 implements keyword spotting and/or automatic speech recognition to identify the word or portion of the word in the audio signal. The sound analysis circuitry 115 identifies or determines if the word or the portion of the word is a keyword or a portion of a keyword. For example, the sound analysis circuitry 115 may identify sounds in the word or portion of the word to identify the word as a keyword. In some examples, the sound analysis circuitry 115 determines that a word is a keyword based on context and/or before speaker begins to speak the keyword. For example, if a speaker says “mother,” the sound analysis circuitry 115 may identify that the keyword “fucker” is about to be present in the audio signal. If a keyword or portion of a keyword is not detected, the unmodified audio signal is transmitted, presented, and/or otherwise output. For example, the interface circuitry 110 delivers the unmodified audio signal to the output 130. In some examples, the output 130 includes one or more electroacoustic transducers such as, for example, loudspeakers.

In some examples, the sound analysis circuitry 115 determines if the keyword can be replaced in the audio signal. For example, the system 100 operates in real time and there may be examples in which a keyword is too short of a duration to modify. In other examples, the latency of a data transmission rate of the audio signal may be too short to enable modification of a keyword. In other examples, speaker attributes such as, for example, clarity of speech, accent, language, etc. may impeded modification of the keyword. If the keyword cannot be replaced, the unmodified audio signal is transmitted, presented, and/or otherwise output (e.g., via the output 130).

In some examples, the sound analysis circuitry 115 determines a presence of the keyword or portion of the keyword that can be modified. In this example, the sound analysis circuitry 115 implements a sound replacement and/or modification of the keyword or portion of the keyword. The sound analysis circuitry 115 may implement different sound modification algorithms, protocols, or techniques. The different sound modification techniques disclosed herein may be used separately and/or in different combinations or sub-combinations.

In some examples, when the sound analysis circuitry 115 detects a keyword, a sound replacement algorithm is activated. In an example algorithm the sound analysis circuitry 115 accesses a database including, for example, a table of keywords to be detected and the substitute words to use with respective keywords. In some examples, the table also may contain a waveform of the sound of the substitute word that is to replace a segment of speech for they keyword or a latter part of the keyword. For example, if the sound analysis circuitry 115 detects the sound “fuh,” which is a portion of the keyword “fuck,” the sound analysis circuitry 115 access the table of keywords and replacement words and identifies the replacement word “fudge” as corresponding to the keyword “fuck.” The sound analysis circuitry 115 modifies the audio signal so that the latter portion of the keyword “fuck” (i.e., the hard ‘k’ sound) is transformed into the sound “dge” (or a “j” sound).

The buffer 120 temporarily stores in the audio signal, and the sound analysis circuitry inserts the waveform for the replacement word or portion of the replacement word into the audio signal so that there is a low latency with the delivery of the audio signal to the listener. The modified audio signal is output via the output 130 (e.g., one or more loudspeakers). In the prior example, the sound presented to the listener is the word “fudge.”

In some examples, the table also may contain a respective duration to substitute for the latter part of the keyword. In some examples, the duration may be modified from original speech in the audio signal.

Many alternative replacement algorithms could be used for further refining the waveform for achieving good continuity in the speech stream with the new speech segment substituted to replace the original signal. In some examples, as disclosed herein, the continuity is provided in terms of both time of the speech and of the voice of the speaker. With continuity of time, the sound of the replacement word or portion of the word is made to match the cadence and/or rate of speech of the original audio signal. With continuity of voice, speaker attributes are considered to make the sound of the replacement word or portion of the word match the voice of the original speaker so the modified sound does not sound like two different people speaking.

In some examples, less continuity is desired. With less continuity, there may be an unnatural sound because the speech of one person is mixed with the speech of another person. A listener may want the audio stream to sound less natural or otherwise hear some discontinuity as a hint that the speaker is using toxic language or otherwise saying keywords.

The example sound modification circuitry 105 also avoids false alarms. A false alarm includes the sound modification circuitry 105 modifying a word that is not a keyword. For example, with short keywords (some toxic words are only one syllable), the entire word is recognized. In this example, latency from the buffer 120 is advantageous and enables the sound modification circuitry 105 to replace the second half or latter part of the short keyword. With longer keywords, the sound modification circuitry 105 mitigates the risk of a false alarm by balancing a false alarm rate against latency. In other words, the delay in the buffer 120 may be adjusted to change the time the sound analysis circuitry 115 uses to analyze the speech and/or modify the speech, which may affect the false alarm rate.

In some examples, the sound replacement algorithm acts on the buffer 120 to adjust the latency in the buffer 120. Keywords vary in their durations and the length of the buffer may be selected minimize latency while also being able to protect the listener from perceiving that they heard any keywords. If the system 100 were set so that the listener would not hear any part of a keyword, the buffer 120 would operate based on the longest duration keyword. The sound analysis circuitry 115 flags that a keyword has been spoken shortly after the completion of that keyword in the speech of the audio signal. In this example, the latter part of the keyword is to be substituted, which will be at the end of the buffer. In other examples, to reduce the latency, the duration of the buffer 120 is reduced by the length of the initial part of the keywords. For example, the latency or duration of the buffer may be based on the duration of the first one or two phonemes of a keyword. A listener may hear the beginning of a keyword that may sound the same as a benign word. Thus, the listener would still be protected from hearing the keyword.

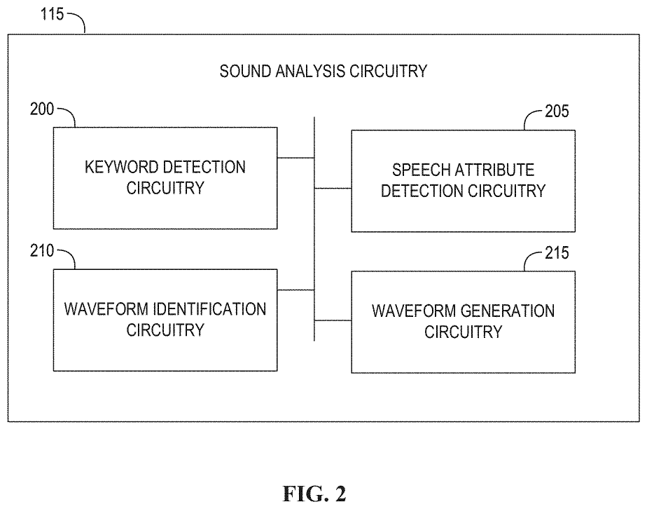

FIG. 2 is a block diagram of a first example sound analysis circuitry 115 of FIG. 1. The example sound analysis circuitry 115 includes example keyword detection circuitry 200, example speech attribute circuitry 205, example waveform identification circuitry, and example waveform generation circuitry 215. The example sound analysis circuitry 115 implements an example waveform generation and replacement algorithm.

The keyword detection circuitry 200 identifies one or more keywords in the speech in the audio signal. For example, as disclosed above, the keyword detection circuitry implements keyword spotting, automatic speech recognition, and/or other algorithms to identify words in speech.

The speech attribute detection circuitry 205 identifies speaker attributes, particularly attributes of speech of a speaker. For example, the speech attribute detection circuitry 205 identifies a voice, a speaking rate, a language, a sex, an approximate age, a volume, a tone, an emotion, an accent, a pitch, a timbre, a vocal register, a hoarseness, a breathiness, a prosody, a clarity, a rhythm, a disfluency, a style, and/or other features or characteristics of speech of a speaker.

The waveform identification circuitry 210 accesses the database 125 (FIG. 1) and identifies a replacement waveform based on the keyword. For example, if the keyword is “fuck,” the waveform identification circuitry 210 may identify the replacement waveform for the word “fudge” to change the sound of the keyword. In some examples, the waveform identification circuitry 210 also identifies the replacement waveform based on one or more of the speaker attributes. In some examples, the database may have multiple versions of waveforms for keywords based on different attributes. For example, the database may include a waveform for the term “fudge” in a male voice and a waveform for the term “fudge” in a female voice. If the speech attribute detection circuitry 205 identifies the speaker as a male, the waveform identification circuitry 210 selects the replacement waveform for the word “fudge” in a male voice. The database 125 may include volumes of samples of different waveforms based on multiple speaker attributes and multiple combinations of different ones of the speaker attributes to further refine the replacement waveform.

In some examples, the database 125 is remote to the sounds modification circuitry 105 and/or remote to one or more of the speaker and/or the listener. A remote database is accessed via communication channels including, for example, wireless communication channels.

Additionally or alternatively, in some examples, the waveform generation circuitry 215 modifies the replacement waveform based on the speaker attributes. Thus, in this example, the waveform identification circuitry 210 identifies a raw replacement waveform. The raw replacement waveform is a coarse modification that includes a relatively simple or basic waveform to provide a framework for a finer replacement waveform. The waveform generation circuitry 215 refines the raw replacement waveform based on one or more speaker attributes to generate the replacement waveform. For example, the waveform generation circuitry 215 may modify or adjust the raw waveform to match a speaker's sex, approximate age, volume, speaking rate, and emotion. Matching the speaker attributes to refine the replacement waveform increases continuity in time and sound of the speech in the modified audio signal. The replacement waveform conceals the keyword.

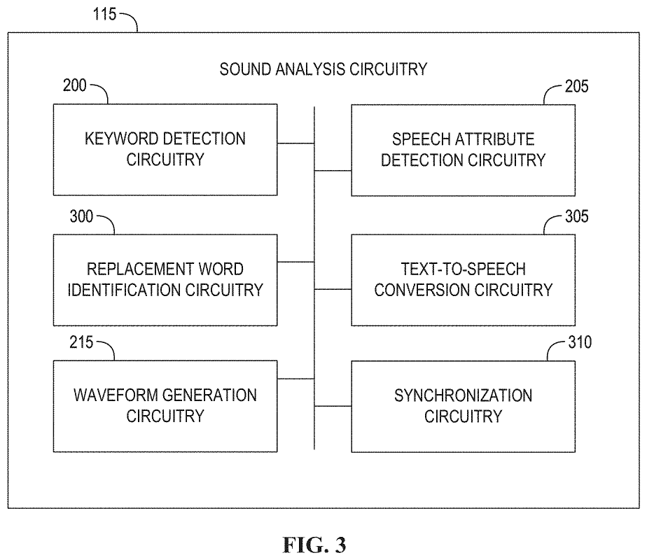

FIG. 3 is a block diagram of a second example sound analysis circuitry 115 of FIG. 1. The example sound analysis circuitry 115 includes the keyword detection circuitry 200, the speech attribute detection circuitry 205, the example waveform generation circuitry 215, example replacement word identification circuitry 300, example text-to-speech conversion circuitry 305, and example synchronization circuitry 310. The example sound analysis circuitry 115 implements an example text-to-speech waveform generation and replacement algorithm. One or more aspects of the example of FIG. 3 may be combined with one or more aspects of the example of FIG. 2.

The keyword detection circuitry 200 identifies one or more keywords in the speech in the audio signal, and the speech attribute detection circuitry 205 identifies speaker attributes, as disclosed above. The replacement word identification circuitry 300 accesses the database 125 (FIG. 1) and identifies a replacement word based on the keyword. Unlike the prior example, in which a waveform for a replacement word is identified, in the example of FIG. 3, the text of the replacement word is identified by the replacement word identification circuitry 300. In some examples, the database 125 includes fewer entries corresponding to keywords when the database 125 includes text replacement words as opposed to multiple variations of waveforms to produce replacements words in accordance with different speaker attributes.

The text-to-speech conversion circuitry 305 converts the text to speech. In other words, the text-to-speech conversion circuitry 305 generates audio of the replacement word. Additionally or alternatively, in some examples, the waveform generation circuitry 215 modifies the audio of the replacement word based on the speaker attributes. Thus, in this example, the text-to-speech conversion circuitry 305 generates a raw replacement waveform, and the waveform generation circuitry 215 refines the raw replacement waveform based on one or more speaker attributes to generate the replacement waveform as disclosed above.

In some examples, the text-to-speech conversion circuitry and waveform generation circuitry 215 are combined. In this example, the speaker attributes are considered during the conversion of the text to speech. The resulting waveform is refined to enhance continuity with the original audio signal. The synchronization circuitry 310 synchronizes the replacement waveform with the original audio such that the replacement waveform conceals the keyword.

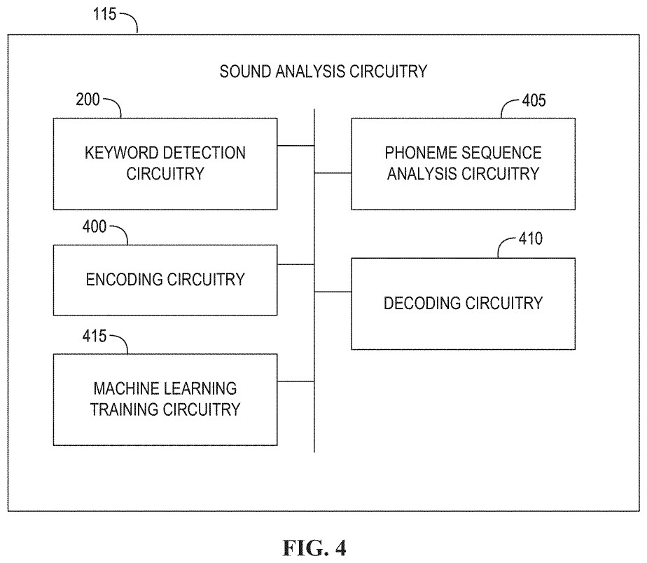

FIG. 4 is a block diagram of a third example sound analysis circuitry 115 of FIG. 1. The example sound analysis circuitry 115 includes the keyword detection circuitry 200, example encoding circuitry 400, example phoneme sequence analysis circuitry 405, example decoding circuitry 410, and example machine learning training circuitry 415. The example sound analysis circuitry 115 implements an example conditional autoencoding algorithm. One or more aspects of the example of FIG. 4 may be combined with one or more aspects of either of the examples of FIG. 2 and/or FIG. 3.

The keyword detection circuitry 200 analyzes the audio signal and identifies one or more keywords in the speech in the audio signal, as disclosed above. The phoneme sequence analysis circuitry 405 identifies a source phoneme sequence of the keyword. A phoneme is a unit of sound. Different phonemes distinguish different words. The phoneme sequence represents the content of the audio signal. Phonemes and sequences of phonemes are written using the International Phonetic Alphabet (IPA). IPA symbols represent sounds. The keyword “fuck” has a phoneme expressed as [symbol] . In examples disclosed herein, the source phoneme sequence is identified by the keyword detection circuitry 200 with minimum latency and high certainty. For example, the keyword detection circuitry 200 may employ a keyword spotting algorithm. When this algorithm is triggered, the phoneme sequence of the keyword is known immediately by accessing the information in a table or other database (e.g., database 125). The latency that occurs to identify this information is much less than in other speech recognition methods because a full graph search of an entire language to recognize which words were spoken is not needed. The phoneme sequence analysis circuitry just decodes one graph for the given keyword.

The phoneme sequence analysis circuitry 405 also determines a phoneme sequence mapping from the source phoneme sequence to a target phoneme sequence. For example, a target phoneme sequence may be identified based on the keyword. For example, a table or other database may be used as disclosed above. In the example with the keyword “fuck,” the target phoneme sequence could be the phoneme for the word “fudge.” The word “fudge” has a phoneme expressed as [symbol] . The phoneme sequence analysis circuitry 405 maps the phoneme sequences from the source phoneme sequence to the target phoneme sequence. In this example, the phoneme sequence analysis circuitry 405 maps [symbol] to [symbol] .

The encoding circuitry 400 processes the speech input including the keyword and reduces the audio signal into components. For example, the encoding circuitry 400 disentangles the factors of the audio signal. The input audio has many factors. For example, the audio signal includes factors such as, for example, content and speaker attributes such as, for example, prosody, pitch, timbre, etc. In some examples, the machine learning training circuitry 415 is leveraged when the factors of the audio signal are disentangled in the latent embedding space. For example, in an input audio frame there may be 160 samples. In respective ones of these samples, information about one or more of pitch, timbre, and/or content is conveyed. The conveyance of these factors is not a simple delineation where sample 1 is the pitch, sample 2 is the timbre, etc. This is because the factors are entangled. Some deep models, including conditional autoencoding, the representations or embeddings are learned in the form of vectors. The elements of respective ones of the vectors are highly correlated with one or more of the factors in the audio input. Visualization of the vectors represents some qualities of the input audio. The disentangled factors show the different qualities of the input audio separate from the content. Thus, the disentangled factors are independent speech representations.

The decoding circuitry 410 resynthesizes the speech as audio or features that can be transformed into audio. The decoding circuitry 410 builds a replacement waveform based on the target phoneme sequence and one or more of the disentangled factors. The decoding circuitry uses the target phoneme sequence representing the replacement word in place of the detected keyword with the other speech representations. With this approach, the other speech characteristics (prosody and other speaker attributes) are maintained. The continuity of sound in the modified audio signal is smooth.

In some examples, the machine learning training circuitry 415 is trained within the Generative Adversarial (GAN) framework. In other examples, other neural networks may be used. In some examples, the machine learning training circuitry 415 also implements one or more algorithms to train and/or optimize the network. For example, the machine learning training circuitry 415 implements a real/fake discrimination model via generative modeling to determine if the modified audio signal is a real or generated sample. Generative modeling is an unsupervised learning task used to automatically discover and learn patterns in input data in such a way that the model can be used to generate or output new examples that could have been drawn from the original signal. In some examples, adversarial loss is employed to train the generator network to produce samples that are indistinguishable from real samples. Adversarial loss is the component of the loss function that corresponds to the samples generated by the generator network in GAN framework. As this loss is minimized, the generator samples are closer to real ones.

In some examples, the machine learning training circuitry 415 implements a speaker discrimination model. In some examples, the speaker discrimination model uses standard training loss function or straightforward loss to maintain speaker characteristics. In some examples, the straightforward loss includes a loss function in a standard training setup, without GAN. In some examples, the speaker discrimination model implements a standard audio classification topology, such as for example, a Convolutional-Recurrent Network (CRNN) or a transformer network.

In some examples, the machine learning training circuitry 415 implements a speech recognition model. For example, the machine learning training circuitry 415 verifies that re-synthesized audio contains desired and intelligible speech content.

Conditional autoencoding networks for speech processing can operate with minimum latency. In some examples, the conditional autoencoding network of FIG. 4 employs time-domain convolutional architectures. Compared to frequency-domain, an advantage of time-domain is that a time domain network can directly produce samples of speech. In turn, a frequency domain method produces fast Fourier transform (FFT) frames that have fixed length (e.g., 2048 samples) and have to be transformed into waveform samples by inverse Fourier Transform, which adds to the latency.

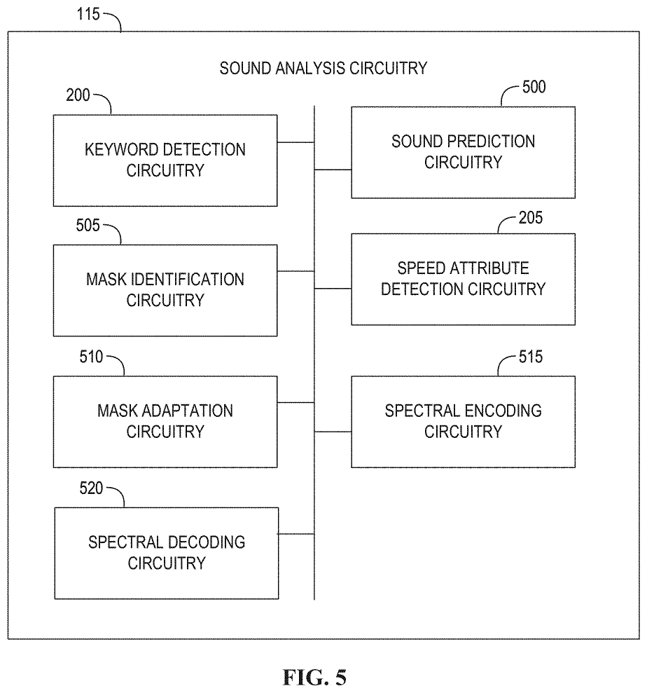

FIG. 5 is a block diagram of a fourth example sound analysis circuitry 115 of FIG. 1. The example sound analysis circuitry 115 includes the keyword detection circuitry 200, the speech attribute detection circuitry 205, example sound prediction circuitry 500, example mask identification circuitry 505, example mask adaptation circuitry 510, example spectral encoding circuitry 515, and example spectral decoding circuitry 520. The example sound analysis circuitry 115 implements a spectral masking algorithm. One or more aspects of the example of FIG. 5 may be combined with one or more aspects of any of the examples of FIG. 2, FIG. 3, and/or FIG. 4.

The example spectral masking algorithm minimizes the latency on the real-time speech stream while concealing a keyword by masking it. In some examples, the spectral masking algorithm is based on a deep neural network (DNN) that continuously predicts the appropriate or effective mask needed to conceal keywords. In some examples, the prediction is based on the most recent segment of the audio signal of the prior speech. In some examples, the DNN has been previously trained on a large corpus of speech to predict the mask parameters with the ideal masks in the training data generated to conceal or suppress the keyword(s) but pass non-keyword including non-toxic speech. Because of the prior training of the DNN, the predicted masks are able to be modified to be effective for the particular person's voice and the speaking rate and also based on what has been said so far as based on the audio signal history.

In the example of FIG. 5, the keyword detection circuitry 200 analyzes the audio signal and identifies one or more keywords in the speech in the audio signal, as disclosed above. The speech attribute detection circuitry 205 analyzes the audio signal and identifies one or more attributes of the speaker of the speech in the audio signal, as disclosed above.

The sound prediction circuitry 500 also analyzes the audio signal. The sound prediction circuitry 500 predicts one or more sounds of one or more word segments using past speech frames to predict how a voice would say a keyword. In some examples, the sound prediction circuitry 500 implements a neural network to use the past speech frames of the particular voice to form this prediction. The sound prediction circuitry predicts the spectrum of how that speaker would say the keyword word. In some examples, the training data used for the neural network covers many different voices, many different keywords, and many different contexts, and combinations thereof to make those predictions. In some examples, the sound prediction circuitry 500 uses the initial part of a keyword to predict the spectrum of the sounds that follow later for that keyword and/or other keywords that also happen to share the same initial sounds.

In some examples, the prediction from the neural network also takes account of the context of preceding words. For example, the word following “you” in the utterance “you ***” could be offensive or praise. In some examples, the neural network is trained on a corpus of speech examples that includes the keyword so that the mask prediction will suppress the sounds in keyword including typical offensive words that are used in the training set. In this example, any keyword including offensive words preceded by the word “you” will become what the neural network uses to predict a dynamic mask for the sequence of sounds in commonly occurring keywords in this context as they unfold.

The mask identification circuitry 505 identifies a spectrum to mask the predicted sounds. The masking spectrum is to suppress the spectrum of the predicted sounds. In some examples, the masking technique implements time frequency masking. Time frequency masking may be used for noise suppression and/or voice separation to separate one or more voices from each other into individual streams. In some examples, the speech signal is transformed into the short-term frequency domain so that a frame of speech is represented by a vector where each element is in the form of its spectral magnitude and phase. The magnitude of the spectrum can be modified by applying a time frequency mask where the mask is either binary (0 or 1) or a parameter in the range 0 to 1. In some examples, magnitude modification uses element wise multiplication. In some examples, where a signal has been corrupted by noise, a goal may be to suppress those spectral elements dominated by the noise while preserving those with a high signal to noise ratio. The application of the spectral mask modifies the magnitude of the time frequency spectrum and is then used to reconstruct a speech signal for replay to the user with the noise reduced.

In some examples, the time frequency mask is dynamically estimated in such a way that that the mask suppresses the spectral elements of the time sequence of sounds in a possible keyword. If the source speech does contain a keyword, the time frequency mask (at each speech frame in time) causes the keyword to be suppressed and/or distorted to such degree that the keyword is no longer intelligible. The listener will not hear the keyword where the mask covers the spectrum of the entire keyword. In other examples, the listener may hear only the first portion of the keyword, where the mask covers the spectrum of the latter portion of the keyword. If the source speech does not contain a keyword (e.g., the word is an inoffensive word), the spectrum of the non-keyword will be sufficiently different from the mask. In other words, there is little spectral overlap between the non-keyword at a particular time frame and the mask. Thus, the spectrum of the non-keyword will be minimally impacted by the mask, and the non-keyword will pass through to the reconstructed speech that is output. The listener will hear the non-keyword.

For example, consider the words “bottom” and “bottle,” where “bottom” is a keyword and “bottle” is a non-keyword. Both have the same sounds in the initial part of the word while they differ in the latter part. The word “bottom” will be part of the set of keywords used to train the predictor. During a speech modification process, the mask identification circuitry 505 will generate or identify a predicted mask for the “o” sound in the latter portion of the keyword based on inputs from the sound prediction circuitry 500 after analysis of the initial sounds. If the input audio signal contains the “/o/” sound in the latter half of the word, the “/o/” sound will be masked. However, if the input audio signal contains the “/uh/” sound from the latter portion of “bottle,” the mask is still the same, but the “/uh/” sound passes through.

The mask adaptation circuitry 510 adapts the mask in accordance with speaker attributes including the speaker's voice and speaking rate. Thus, there is not a single spectral mask. In some examples, the mask at one or more of the frames and/or each frame is predicted by the mask identification circuitry 505. In some examples, the mask identification circuitry 505 and/or the mask adaptation uses a DNN based on the history of speech frames for the particular speaker's voice. Thus, in some examples, the mask is therefore adaptive to the particular context and the particular voice of the speaker.

The input audio signal is processed by the spectral encoding circuitry 515. In some examples, the spectral encoding circuitry 515 transforms the audio signal to the frequency domain. In some examples, the spectral decoding circuitry 520 applies the mask. As noted above, in some examples, the mask dynamically changes with changes frames of the audio signal. The spectral magnitude of the speech is modified by the mask applied when keywords associated with the mask are present in the audio signal. The spectral decoding circuitry 520 reconstructs the output speech waveform. In some examples, the buffer 120 is used to introduce a low latency during generation, adaptation, and application of the mask.

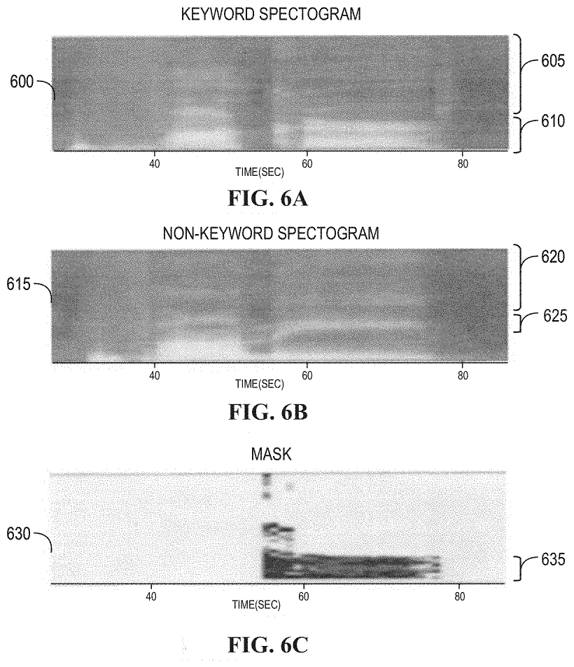

FIG. 6A is an example spectrogram 600 of a first example word. In particular, FIG. 6A shows the spectrogram 600 of the word “fucker,” which is a keyword in this example. The spectrogram 600 includes a first part 605, which represents the spectrum of a first portion of the word. The first portion of the word corresponds to the sound “fuh.” The spectrogram 600 includes a second part 610, which represents the spectrum of a second portion of the word. The second portion of the word corresponds to the sound “ker.”

FIG. 6B is an example spectrogram 615 of a second example word. In particular, FIG. 6A shows the spectrogram 615 of the word “funny,” which is a non-keyword in this example. The spectrogram 615 includes a first part 620, which represents the spectrum of a first portion of the word. The first portion of the word corresponds to the sound “fuh.” Thus, the spectrum of the first portion 620 of the word “funny” shown in FIG. 6B is similar to the spectrum of the first portion 605 of the word “fucker” shown in FIG. 6A because the respective portions of these words sound similar. The spectrogram 600 includes a second part 625, which represents the spectrum of a second portion of the word. The second portion of the word corresponds to the sound “nee.” The spectrum of the second portion 625 of the word “funny” shown in FIG. 6B is different than the spectrum of the second portion 610 of the word “fucker” shown in FIG. 6A because the respective portions of these words sound different.

FIG. 6C is an example spectrogram 630 that includes an example spectral mask 635. The mask 635 covers the portion of the spectrum aligned with the “ker” sound of the keyword of FIG. 6A. The “nee” sound of the non-keyword of FIG. 6B is located outside of the spectrum of the spectral mask. Thus, when the spectral mask 635 is applied to an audio signal, if a speaker says the word “fucker,” the “ker” sound will be suppressed or concealed by the spectral mask. The mask suppresses the time frequency points with high spectral energy in the second half (i.e., “ker”). In this example, the listener would only hear the “fuh” sound that passes outside of the spectral mask 635. However, if a speaker says the word “funny,” no sounds will be suppressed by the spectral mask 635. The position 625 of the “nee” sound is located at a frequency that is above the point where the mask 635 is applied. In this example, the listener would hear the entire non-keyword “funny.”

In some examples, spectral masking may also be used for voice separation, as noted above. In voice separation the neural network is trained on many examples of different combinations of pairs of overlapping voices. The network learns the prediction of the mask to use to separate respective ones of the voices from the other. In some examples, based on the continuity of respective individual voices in the mixture, the network projects what mask will be effective at separating the voices (i.e., to pass one voice through and suppress the another). With time frequency masking, two or more voices mixed together, even where they fully overlap, can largely be separated out into individual streams for respective ones of the voices so that the voices can be heard with reasonable quality and without hearing an interfering talker. In some examples, the masking can be used to completely mask a voice.

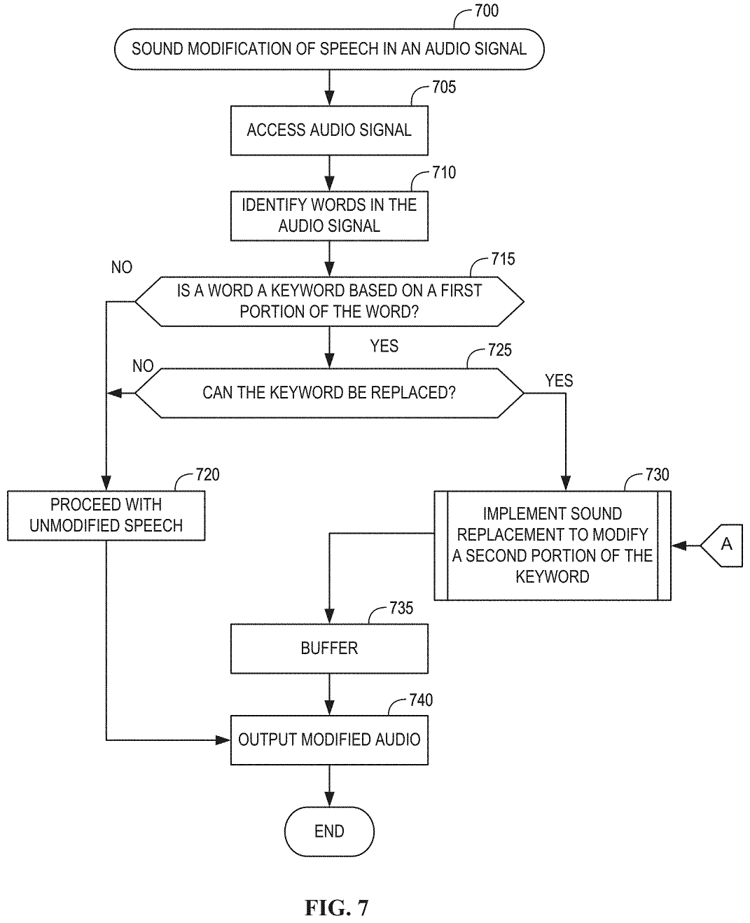

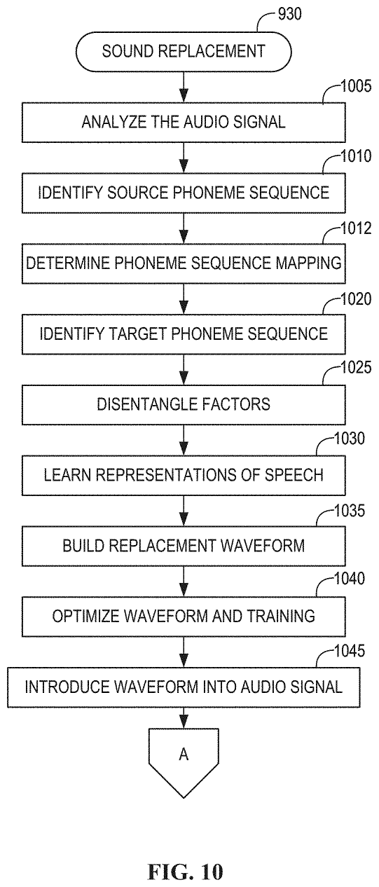

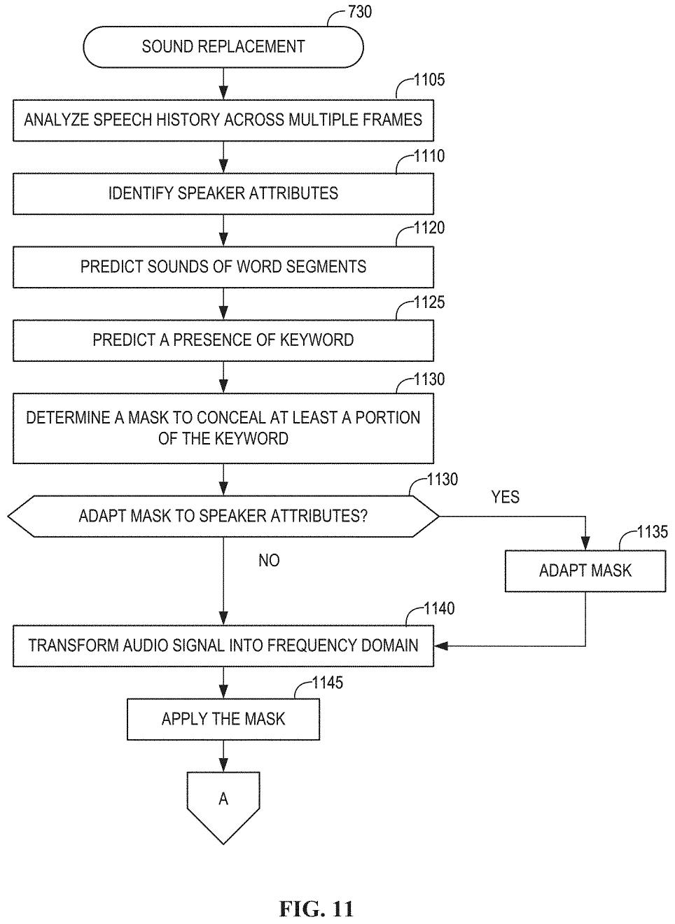

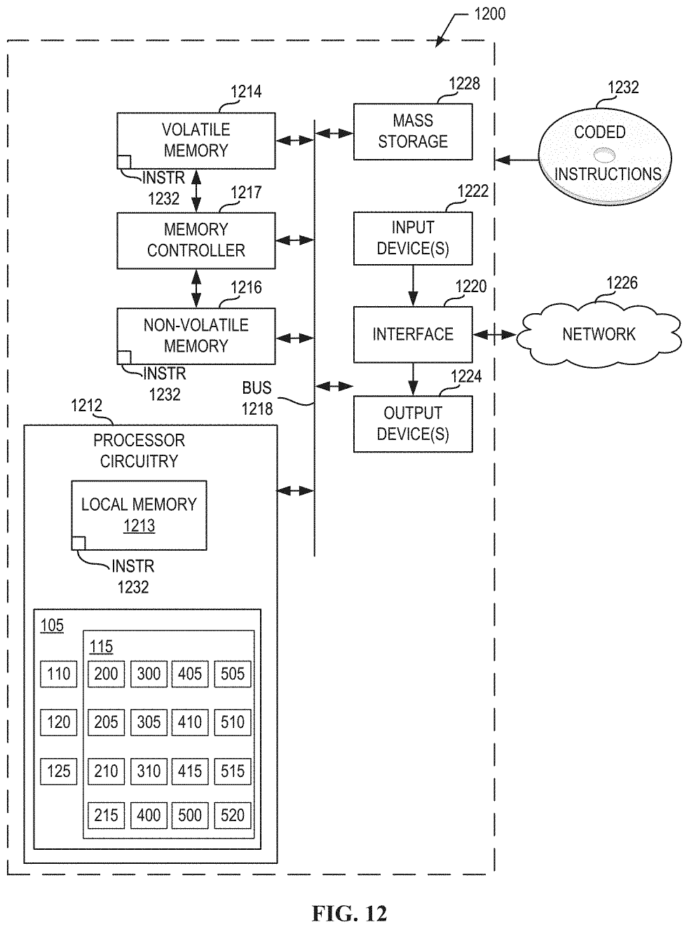

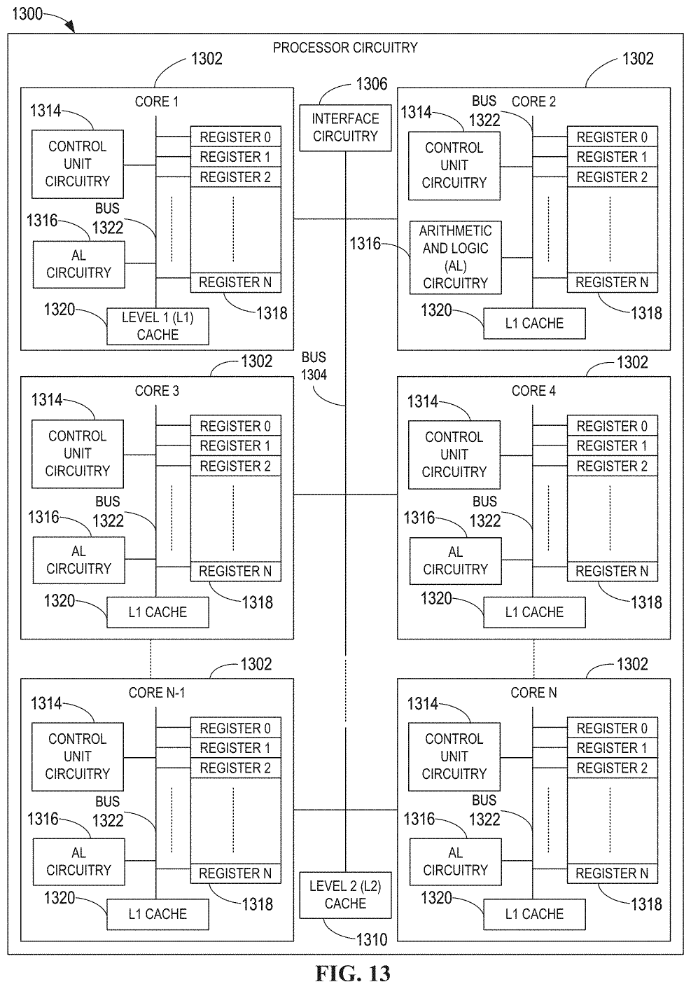

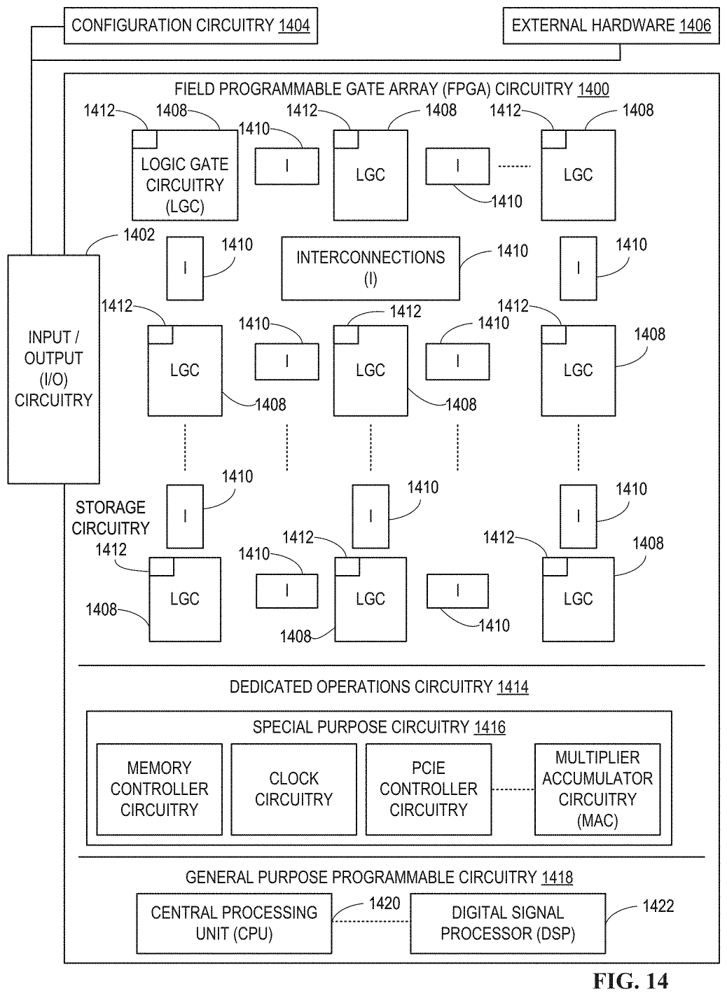

In some examples, the apparatus includes means for identifying a first portion of a keyword. For example, the means for identifying may be implemented by the keyword detection circuitry 200. In some examples, the keyword detection circuitry 200 may be implemented by machine executable instructions such as that implemented by at least blocks 710, 715 of FIG. 7, block 1005 of FIG. 10, and/or block 1105 of FIG. 11 executed by processor circuitry, which may be implemented by the example processor circuitry 1212 of FIG. 12, the example processor circuitry 1300 of FIG. 13, and/or the example Field Programmable Gate Array (FPGA) circuitry 1400 of FIG. 14. In other examples, the keyword detection circuitry 200 is implemented by other hardware logic circuitry, hardware implemented state machines, and/or any other combination of hardware, software, and/or firmware. For example, the keyword detection circuitry 200 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

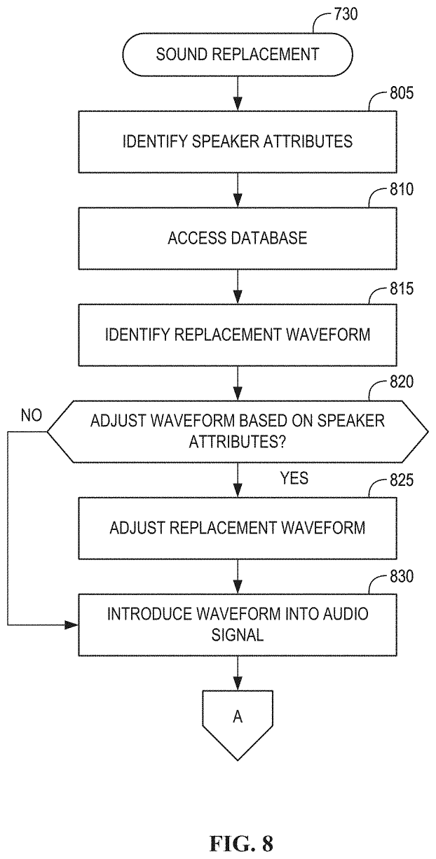

In some examples, the apparatus includes means for determining a waveform to replace a second portion of the keyword. For example, the means for determining may be implemented by the waveform identification circuitry 210. In some examples, the waveform identification circuitry 210 may be implemented by machine executable instructions such as that implemented by at least block 810 of FIG. 8 executed by processor circuitry, which may be implemented by the example processor circuitry 1212 of FIG. 12, the example processor circuitry 1300 of FIG. 13, and/or the example FPGA circuitry 1400 of FIG. 14. In other examples, the keyword detection circuitry 200 is implemented by other hardware logic circuitry, hardware implemented state machines, and/or any other combination of hardware, software, and/or firmware. For example, the keyword detection circuitry 200 may be implemented by at least one or more hardware circuits (e.g., processor circuitry, discrete and/or integrated analog and/or digital circuitry, an FPGA, an ASIC, a comparator, an op-amp, a logic circuit, etc.) structured to perform the corresponding operation without executing software or firmware, but other structures are likewise appropriate.

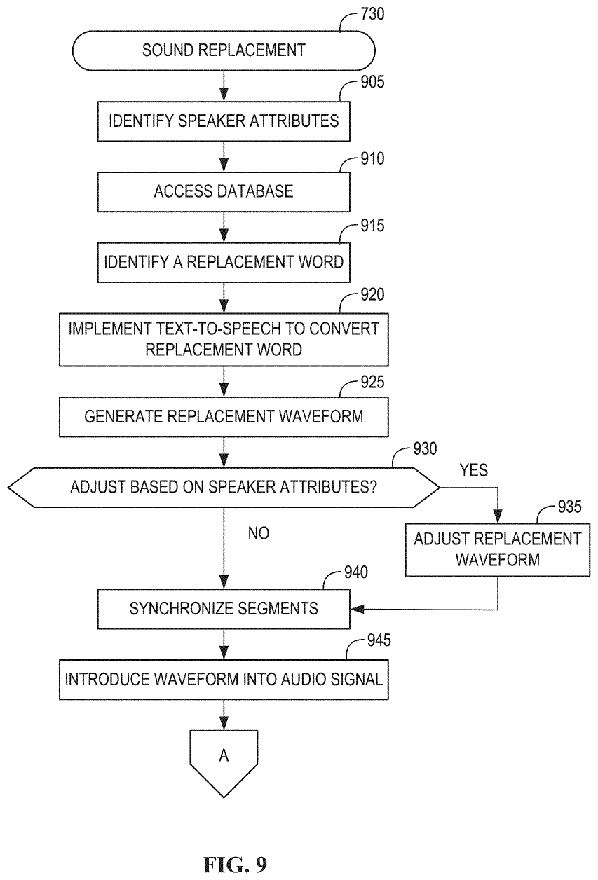

In some examples, the apparatus includes means for introducing a waveform into an audio signal. For example, the means for introducing may be implemented by the waveform generation circuitry 215, the text-to-speech-conversion circuitry 305, and/or the decoding circuitry 410. In some examples, the waveform generation circuitry 215, the text-to-speech-conversion circuitry 305, and/or the decoding circuitry 410 may be implemented by machine executable instructions such as that implemented by at least blocks 820, 825, 830 of FIG. 8, blocks 920, 925, 930, 935 of FIG. 9, and/or block 1035 of FIG. 10 executed by processor circuitry, which may be implemented by the example processor circuitry 1212 of FIG. 12, the example processor circuitry 1300 of FIG. 13, and/or the example FPGA circuitry 1400 of FIG. 14. In other examples, the keyword detection circuitry 200 is implemented by other hardware logic circuitry, hardware implemented state machines, and/or any other combination of hardware, software, and/or firmware. For example, the waveform generation circuitry 215, the text-to-speech-conversion circuitry 305, and/or the decoding circuitry 410 may be implemented by at least one or more hardware circuits (e.g., processor circuitry, discrete and/or integrated analog and/or digital circuitry, an FPGA, an ASIC, a comparator, an op-amp, a logic circuit, etc.) structured to perform the corresponding operation without executing software or firmware, but other structures are likewise appropriate.

In some examples, the apparatus includes means for identifying an attribute of speech. For example, the means for identifying may be implemented by the speech attribute detection circuitry 205. In some examples, the speech attribute detection circuitry 205 may be implemented by machine executable instructions such as that implemented by at least block 805 of FIG. 8, block 905 of FIG. 9, and/or block 1110 of FIG. 11 executed by processor circuitry, which may be implemented by the example processor circuitry 1212 of FIG. 12, the example processor circuitry 1300 of FIG. 13, and/or the example FPGA circuitry 1400 of FIG. 14. In other examples, the keyword detection circuitry 200 is implemented by other hardware logic circuitry, hardware implemented state machines, and/or any other combination of hardware, software, and/or firmware. For example, the speech attribute detection circuitry 205 may be implemented by at least one or more hardware circuits (e.g., processor circuitry, discrete and/or integrated analog and/or digital circuitry, an FPGA, an ASIC, a comparator, an op-amp, a logic circuit, etc.) structured to perform the corresponding operation without executing software or firmware, but other structures are likewise appropriate.

In some examples, the apparatus includes means for identifying text of a different word based on a keyword. For example, the means for identifying may be implemented by the replacement word identification circuitry 300. In some examples, the replacement word identification circuitry 300 may be implemented by machine executable instructions such as that implemented by at least block 915 of FIG. 9 executed by processor circuitry, which may be implemented by the example processor circuitry 1212 of FIG. 12, the example processor circuitry 1300 of FIG. 13, and/or the example FPGA circuitry 1400 of FIG. 14. In other examples, the replacement word identification circuitry 300 is implemented by other hardware logic circuitry, hardware implemented state machines, and/or any other combination of hardware, software, and/or firmware. For example, the replacement word identification circuitry 300 may be implemented by at least one or more hardware circuits (e.g., processor circuitry, discrete and/or integrated analog and/or digital circuitry, an FPGA, an ASIC, a comparator, an op-amp, a logic circuit, etc.) structured to perform the corresponding operation without executing software or firmware, but other structures are likewise appropriate.

In some examples, the apparatus includes means for converting the text to speech. For example, the means for converting may be implemented by the text-to-speech conversion circuitry 305. In some examples, the text-to-speech conversion circuitry 305 may be implemented by machine executable instructions such as that implemented by at least blocks 920, 925 of FIG. 9 executed by processor circuitry, which may be implemented by the example processor circuitry 1212 of FIG. 12, the example processor circuitry 1300 of FIG. 13, and/or the example FPGA circuitry 1400 of FIG. 14. In other examples, the text-to-speech conversion circuitry 305 is implemented by other hardware logic circuitry, hardware implemented state machines, and/or any other combination of hardware, software, and/or firmware. For example, the text-to-speech conversion circuitry 305 may be implemented by at least one or more hardware circuits (e.g., processor circuitry, discrete and/or integrated analog and/or digital circuitry, an FPGA, an ASIC, a comparator, an op-amp, a logic circuit, etc.) structured to perform the corresponding operation without executing software or firmware, but other structures are likewise appropriate.

In some examples, the apparatus includes means for analyzing phonemes. For example, the phoneme analysis means may be implemented by the phoneme sequence analysis circuitry 405. In some examples, the phoneme sequence analysis circuitry 405 may be implemented by machine executable instructions such as that implemented by at least blocks 1005, 110, 1015, 1020 of FIG. 10 executed by processor circuitry, which may be implemented by the example processor circuitry 1212 of FIG. 12, the example processor circuitry 1300 of FIG. 13, and/or the example FPGA circuitry 1400 of FIG. 14. In other examples, the phoneme sequence analysis circuitry 405 is implemented by other hardware logic circuitry, hardware implemented state machines, and/or any other combination of hardware, software, and/or firmware. For example, the phoneme sequence analysis circuitry 405 may be implemented by at least one or more hardware circuits (e.g., processor circuitry, discrete and/or integrated analog and/or digital circuitry, an FPGA, an ASIC, a comparator, an op-amp, a logic circuit, etc.) structured to perform the corresponding operation without executing software or firmware, but other structures are likewise appropriate.

In some examples, the apparatus includes means for implementing a neural network. For example, the means for implementing may be implemented by the machine learning training circuitry 415. In some examples, the machine learning training circuitry 415 may be implemented by machine executable instructions such as that implemented by at least blocks 1030, 1040 of FIG. 10 executed by processor circuitry, which may be implemented by the example processor circuitry 1212 of FIG. 12, the example processor circuitry 1300 of FIG. 13, and/or the example FPGA circuitry 1400 of FIG. 14. In other examples, the machine learning training circuitry 415 is implemented by other hardware logic circuitry, hardware implemented state machines, and/or any other combination of hardware, software, and/or firmware. For example, the machine learning training circuitry 415 may be implemented by at least one or more hardware circuits (e.g., processor circuitry, discrete and/or integrated analog and/or digital circuitry, an FPGA, an ASIC, a comparator, an op-amp, a logic circuit, etc.) structured to perform the corresponding operation without executing software or firmware, but other structures are likewise appropriate.

In some examples, the apparatus includes means for disentangling characteristics of a voice and/or audio signal. For example, the means for disentangling may be implemented by the encoding circuitry 400. In some examples, the encoding circuitry 400 may be implemented by machine executable instructions such as that implemented by at least block 1025 of FIG. 10 executed by processor circuitry, which may be implemented by the example processor circuitry 1212 of FIG. 12, the example processor circuitry 1300 of FIG. 13, and/or the example FPGA circuitry 1400 of FIG. 14. In other examples, the encoding circuitry 400 is implemented by other hardware logic circuitry, hardware implemented state machines, and/or any other combination of hardware, software, and/or firmware. For example, the encoding circuitry 400 may be implemented by at least one or more hardware circuits (e.g., processor circuitry, discrete and/or integrated analog and/or digital circuitry, an FPGA, an ASIC, a comparator, an op-amp, a logic circuit, etc.) structured to perform the corresponding operation without executing software or firmware, but other structures are likewise appropriate.

In some examples, the apparatus includes means for predicting a presence of a keyword in speech. For example, the means for predicting may be implemented by the sound prediction circuitry 500. In some examples, the sound prediction circuitry 500 may be implemented by machine executable instructions such as that implemented by at least blocks 1105, 1115, 1120 of FIG. 11 executed by processor circuitry, which may be implemented by the example processor circuitry 1212 of FIG. 12, the example processor circuitry 1300 of FIG. 13, and/or the example FPGA circuitry 1400 of FIG. 14. In other examples, the sound prediction circuitry 500 is implemented by other hardware logic circuitry, hardware implemented state machines, and/or any other combination of hardware, software, and/or firmware. For example, the sound prediction circuitry 500 may be implemented by at least one or more hardware circuits (e.g., processor circuitry, discrete and/or integrated analog and/or digital circuitry, an FPGA, an ASIC, a comparator, an op-amp, a logic circuit, etc.) structured to perform the corresponding operation without executing software or firmware, but other structures are likewise appropriate.

In some examples, the apparatus includes means for determining a mask. For example, the means for determining may be implemented by the mask identification circuitry 505. In some examples, the mask identification circuitry 505 may be implemented by machine executable instructions such as that implemented by at least block 1125 of FIG. 11 executed by processor circuitry, which may be implemented by the example processor circuitry 1212 of FIG. 12, the example processor circuitry 1300 of FIG. 13, and/or the example FPGA circuitry 1400 of FIG. 14. In other examples, the mask identification circuitry 505 is implemented by other hardware logic circuitry, hardware implemented state machines, and/or any other combination of hardware, software, and/or firmware. For example, the mask identification circuitry 505 may be implemented by at least one or more hardware circuits (e.g., processor circuitry, discrete and/or integrated analog and/or digital circuitry, an FPGA, an ASIC, a comparator, an op-amp, a logic circuit, etc.) structured to perform the corresponding operation without executing software or firmware, but other structures are likewise appropriate.

In some examples, the apparatus includes means for applying a mask. For example, the means for applying may be implemented by the spectral decoding circuitry 520. In some examples, the spectral decoding circuitry 520 may be implemented by machine executable instructions such as that implemented by at least block 1145 of FIG. 11 executed by processor circuitry, which may be implemented by the example processor circuitry 1212 of FIG. 12, the example processor circuitry 1300 of FIG. 13, and/or the example FPGA circuitry 1400 of FIG. 14. In other examples, the spectral decoding circuitry 520 is implemented by other hardware logic circuitry, hardware implemented state machines, and/or any other combination of hardware, software, and/or firmware. For example, the spectral decoding circuitry 520 may be implemented by at least one or more hardware circuits (e.g., processor circuitry, discrete and/or integrated analog and/or digital circuitry, an FPGA, an ASIC, a comparator, an op-amp, a logic circuit, etc.) structured to perform the corresponding operation without executing software or firmware, but other structures are likewise appropriate.

In some examples, the apparatus includes means for adjusting a mask. For example, the means for adjusting may be implemented by the mask adaptation circuitry 510. In some examples, the mask adaptation circuitry 510 may be implemented by machine executable instructions such as that implemented by at least blocks 1130, 1135 of FIG. 11 executed by processor circuitry, which may be implemented by the example processor circuitry 1212 of FIG. 12, the example processor circuitry 1300 of FIG. 13, and/or the example FPGA circuitry 1400 of FIG. 14. In other examples, the mask adaptation circuitry 510 is implemented by other hardware logic circuitry, hardware implemented state machines, and/or any other combination of hardware, software, and/or firmware. For example, the mask adaptation circuitry 510 may be implemented by at least one or more hardware circuits (e.g., processor circuitry, discrete and/or integrated analog and/or digital circuitry, an FPGA, an ASIC, a comparator, an op-amp, a logic circuit, etc.) structured to perform the corresponding operation without executing software or firmware, but other structures are likewise appropriate.

While example manners of implementing the sound modification circuitry 105 is illustrated in FIGS. 1-5, one or more of the elements, processes, and/or devices illustrated in FIGS. 1-5 may be combined, divided, re-arranged, omitted, eliminated, and/or implemented in any other way. Further, the example interface circuitry 110, the example sound analysis circuitry 115, the example buffer 120, the example database 125, the example, keyword detection circuitry 200, the example speech attribute detection circuitry 205, the example waveform identification circuitry 210, the example waveform generation circuitry 215, the example replacement word identification circuitry 300, the example text-to-speech conversion circuitry 305, example synchronization circuitry 310, the example encoding circuitry 400, the example phoneme sequence analysis circuitry 405, the example decoding circuitry 410, the example prediction circuitry 500, the example mask identification circuitry 505, the example mask adaption circuitry 510, the example spectral encoding circuitry 515, the example spectral decoding circuitry 520, and/or, more generally, the example sound modification circuitry 105 of FIG. 1, may be implemented by hardware, software, firmware, and/or any combination of hardware, software, and/or firmware. Thus, for example, any of the example interface circuitry 110, the example sound analysis circuitry 115, the example buffer 120, the example database 125, the example, keyword detection circuitry 200, the example speech attribute detection circuitry 205, the example waveform identification circuitry 210, the example waveform generation circuitry 215, the example replacement word identification circuitry 300, the example text-to-speech conversion circuitry 305, example synchronization circuitry 310, the example encoding circuitry 400, the example phoneme sequence analysis circuitry 405, the example decoding circuitry 410, the example prediction circuitry 500, the example mask identification circuitry 505, the example mask adaption circuitry 510, the example spectral encoding circuitry 515, the example spectral decoding circuitry 520, and/or, more generally, the example sound modification circuitry 105 of FIG. 1, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example interface circuitry 110, the example sound analysis circuitry 115, the example buffer 120, the example database 125, the example, keyword detection circuitry 200, the example speech attribute detection circuitry 205, the example waveform identification circuitry 210, the example waveform generation circuitry 215, the example replacement word identification circuitry 300, the example text-to-speech conversion circuitry 305, example synchronization circuitry 310, the example encoding circuitry 400, the example phoneme sequence analysis circuitry 405, the example decoding circuitry 410, the example prediction circuitry 500, the example mask identification circuitry 505, the example mask adaption circuitry 510, the example spectral encoding circuitry 515, the example spectral decoding circuitry 520, and/or the example sound modification circuitry 105 is/are hereby expressly defined to include a non-transitory computer readable storage device or storage disk such as a memory, a digital versatile disk (DVD), a compact disk (CD), a Blu-ray disk, etc., including the software and/or firmware. Further still, the example sound modification circuitry 105 of FIG. 1 may include one or more elements, processes, and/or devices in addition to, or instead of, those illustrated in FIGS. 1-5, and/or may include more than one of any or all of the illustrated elements, processes and devices.

Flowcharts representative of example hardware logic circuitry, machine readable instructions, hardware implemented state machines, and/or any combination thereof for implementing the sound modification circuitry 105 of FIG. 1 are shown in FIGS. 7-11. The machine readable instructions may be one or more executable programs or portion(s) of an executable program for execution by processor circuitry, such as the processor circuitry 1212 shown in the example processor platform 1200 discussed below in connection with FIG. 12 and/or the example processor circuitry discussed below in connection with FIGS. 13 and/or 14. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowchart illustrated in FIG. 12, many other methods of implementing the example sound medication circuitry 105 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 7-11 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 7 is a flowchart representative of example machine readable instructions and/or example operations 700 that may be executed and/or instantiated by processor circuitry to modify sound of speech in an audio signal. The machine readable instructions and/or operations 700 of FIG. 7 include the sound modification circuitry 105, the interface circuitry 110, and/or the input 130 accessing an audio signal (block 705). The sound analysis circuitry 115 and/or keyword detection circuitry 200 identifies words in the audio signal (block 710).

The sound analysis circuitry 115 and/or keyword detection circuitry determines if the word is a keyword based on at least a first portion of the word (block 715). If the word is not a keyword (block 715: NO), the sound modification circuitry 105 proceed with unmodified speech in the audio signal (block 720). If the word is a keyword (block 715: YES), the sound analysis circuitry 115 determines if the word can be replaced (block 725). If the word cannot be replaced (block 725: NO), the sound modification circuitry 105 proceeds with unmodified speech in the audio signal (block 720). If the word can be replaced (block 725: YES), the sound analysis circuitry 115 implements sound replacement instructions to modify at least a second portion of the keyword (block 730).

The buffer 735 buffers the audio signal (block 735) so the waveforms to modify the sound can be introduced into the audio signal. The sound modification circuitry 105 outputs the modified audio signal via, for example, the interface circuitry 110 and/or the output 135. The example instructions 700 then end.

FIG. 8 is a flowchart representative of first example machine readable instructions and/or example operations 730 that may be executed and/or instantiated by processor circuitry to implement the sound replacement instructions 730 of FIG. 7. The machine readable instructions and/or operations 730 of FIG. 8 include the speech attribute detection circuitry 205 identifying speaker attributes of speech in an audio signal (block 805). The waveform identification circuitry 210 accesses the database 125 (block 810). The database 125 includes tables, maps, and/or other data that correlates or associates keywords and/or portions of keywords with replacement waveforms to be used to modify the sound of the keyword. The waveform identification circuitry 210 identifies a replacement waveform (block 815).

The waveform generation circuitry 215 determines if the waveform is to be adjusted based on speaker attributes (block 820). For example, the waveform may be adjusted to match a sound of the speaker's voice, a rate of speaking, an emotion, etc. If the waveform is to be adjusted based on speaker attributes (block 820: YES), the waveform generation circuitry 215 adjusts the replacement waveform in accordance with one or more of the speaker attributes (block 825). The waveform generation circuitry 215 and/or sound analysis circuitry 115 then introduces the adjusted replacement waveform into the audio signal to modify the sound of the speech in the audio signal (block 830). If the waveform is not to be adjusted based on speaker attributes (block 820: NO), the waveform generation circuitry 215 and/or sound analysis circuitry 115 introduces the replacement waveform into the audio signal to modify the sound of the speech in the audio signal (block 830).

FIG. 9 is a flowchart representative of second example machine readable instructions and/or example operations 730 that may be executed and/or instantiated by processor circuitry to implement the sound replacement instructions 730 of FIG. 7. The machine readable instructions and/or operations 730 of FIG. 9 include the speech attribute detection circuitry 205 identifying speaker attributes of speech in an audio signal (block 905).

The replacement word identification circuitry 300 accesses the database 125 (block 910). The database 125 includes tables, maps, and/or other data that correlates or associates keywords and/or portions of keywords with replacement words to be used to replace the keyword or one or more portions of the keyword. The replacement word identification circuitry 300 identifies a replacement word (block 915).

The text-to-speech conversion circuitry 305 implements text-to-speech conversion of the text of the replacement word into a waveform (block 920). The text-to-speech conversion circuitry 305 and/or the waveform generation circuitry 215 generate the replacement waveform based on the text-to-speech conversion (block 925). In some examples, the implementation of text-to-speech conversion of the text of the replacement word into a waveform and the generation of the replacement waveform based on the text-to-speech conversion are a combined and/or single step. Also, in some examples, the text-to-speech conversion circuitry 305 and the waveform generation circuitry 215 are combined.

The waveform generation circuitry 215 determines if the waveform is to be adjusted based on speaker attributes (block 930). For example, the waveform may be adjusted to match a sound of the speaker's voice, a rate of speaking, an emotion, etc., as discussed above. If the waveform is to be adjusted based on speaker attributes (block 930: YES), the waveform generation circuitry 215 adjusts the replacement waveform in accordance with one or more of the speaker attributes (block 935). The synchronization circuitry 310 synchronizes segments of the audio signal, which may be buffered, with the adjusted replacement waveform (block 940). If the waveform is not to be adjusted based on speaker attributes (block 930: NO), the synchronization circuitry 310 synchronizes segments of the audio signal, which may be buffered, with the replacement waveform (block 940).

The waveform generation circuitry 215 and/or sound analysis circuitry 115 then introduces the adjusted replacement waveform into the audio signal to modify the sound of the speech in the audio signal (block 945).

FIG. 10 is a flowchart representative of third example machine readable instructions and/or example operations 730 that may be executed and/or instantiated by processor circuitry to implement the sound replacement instructions 730 of FIG. 7. The machine readable instructions and/or operations 730 of FIG. 10 include the keyword detection circuitry 200 and the phoneme sequence analysis circuitry 405 analyzing the audio signal (block 1005). The keyword detection circuitry 200 analyzes the audio signal to, for example, detect keywords as disclosed above. The phoneme sequence analysis circuitry 405 analyzes the audio signal to detect sounds included in the signal including, for example, the component sounds of keywords. The phoneme sequence analysis circuitry 405 identifies a source phoneme sequence (block 1010). The source phoneme sequence includes the arrangement of sounds that create the keyword or portion of a keyword.

The phoneme sequence analysis circuitry 405 determines the phoneme sequence mapping (block 1015), and the phoneme sequence analysis circuitry 405 identifies a target phoneme sequence (block 1020). For example, the phoneme sequence analysis circuitry 405 accesses the database 125, which correlates, associates, or maps keywords and replacement words. In some examples, the database 125 includes phonemes of these words. Based on the identified source phoneme sequence of the keyword, the phoneme sequence analysis circuitry 405 identifies a phoneme sequence mapping and the target phoneme sequence.

The example instructions 730 of FIG. 10 also include the encoding circuitry 400 disentangling factors of the audio stream (block 1025). For example, the encoding circuitry 400 separates components of the speech including different aspects of the speaker attributes, speaking rate, components of the speech content, noise, etc. The machine learning training circuitry 415 learns representations of the speech (block 1030). The representations include the factors showing the different qualities of the input audio separate from the content. The decoding circuitry 410 builds a replacement waveform based on the target phoneme sequence and the representations including one or more of the disentangled factors (block 1035). The decoding circuitry and/or sound analysis circuitry 115 introduces the replacement waveform into the audio signal (block 1045). Thus, the speech characteristics are maintained, and there is high continuity of sound in the modified audio signal.

In some examples, there also is a machine learning process in which the machine learning training circuitry 415 implements one or more optimization and/or training functions disclosed above (block 1040). The optimization and/or training functions further enhance the continuity of the modified signal and reduce latency.

FIG. 11 is a flowchart representative of fourth example machine readable instructions and/or example operations 730 that may be executed and/or instantiated by processor circuitry to implement the sound replacement instructions 730 of FIG. 7. The machine readable instructions and/or operations 730 of FIG. 11 include the keyword detection circuitry 200 and the sound prediction circuitry 500 analyzing the audio signal including, for example, the speech history across multiple frames (block 1105). The keyword detection circuitry 200 analyzes the audio signal to, for example, detect keywords as disclosed above. The sound prediction circuitry 500 analyzes the history of the audio signal for prediction purposes as disclosed herein. The speech attribute detection circuitry 205 identifies speaker attributes as disclosed above (block 1110).

The sound prediction circuitry 500 predicts sounds of word segments (block 1115). For example, the sound prediction circuitry 500 can predict the sound of a latter portion of a word based on an initial portion of the word. In some examples, the sound prediction circuitry 500 predicts the presence of a keyword (block 1120) based on the sound prediction. In some examples, the sound prediction circuitry 500 predicts an upcoming keyword based on context including other words that are not keywords.

The mask identification circuitry 505 determines a mask to conceal at least a portion of the keyword (block 1125). For example, the mask identification circuitry 505 identifies a portion of spectrum of the keyword that can be concealed and the corresponding spectral mask to use for the concealment. The mask adaptation circuitry 510 determines if the mask is to be adapted based on speaker attributes (block 1130). For example, the mask may be adapted to meet a voice pitch of the speaker. The mask also may be adapted based on one or more other speaker attributes disclosed herein. If the mask is to be adapted (block 1130: YES), the mask adaptation circuitry 510 adapts the mask (block 1135). The example instructions 730 also include the spectral encoding circuitry 515 transforming the signal into the frequency domain (block 1140). The decoding circuitry 520 applies the adapted mask in the frequency domain (block 1145). If the mask is not to be adapted (block 1130: NO), the example instructions continue with transformation of the audio signal into the frequency domain (block 1140) and application of the mask (block 1145).

FIG. 12 is a block diagram of an example processor platform 1200 structured to execute and/or instantiate the machine readable instructions and/or operations of FIGS. 7-11 to implement the sound modification circuitry 105 of FIG. 1. The processor platform 1200 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1200 of the illustrated example includes processor circuitry 1212. The processor circuitry 1212 of the illustrated example is hardware. For example, the processor circuitry 1212 can be implemented by one or more integrated circuits, logic circuits, FPGAs microprocessors, CPUs, GPUs, DSPs, and/or microcontrollers from any desired family or manufacturer. The processor circuitry 1212 may be implemented by one or more semiconductor based (e.g., silicon based) devices. In this example, the processor circuitry 1212 implements the example sound modification circuitry 105, the example interface circuitry 110, the example sound analysis circuitry 115, the example buffer 120, the example database 125, the example, keyword detection circuitry 200, the example speech attribute detection circuitry 205, the example waveform identification circuitry 210, the example waveform generation circuitry 215, the example replacement word identification circuitry 300, the example text-to-speech conversion circuitry 305, example synchronization circuitry 310, the example encoding circuitry 400, the example phoneme sequence analysis circuitry 405, the example decoding circuitry 410, the example prediction circuitry 500, the example mask identification circuitry 505, the example mask adaption circuitry 510, the example spectral encoding circuitry 515, and/or the example spectral decoding circuitry 520.

The processor circuitry 1212 of the illustrated example includes a local memory 1213 (e.g., a cache, registers, etc.). The processor circuitry 1212 of the illustrated example is in communication with a main memory including a volatile memory 1214 and a non-volatile memory 1216 by a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1216 may be implemented by flash memory and/or any other desired type of memory device. Access to the main memory 1214, 1216 of the illustrated example is controlled by a memory controller 1217.

The processor platform 1200 of the illustrated example also includes interface circuitry 1220. The interface circuitry 1220 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 1222 are connected to the interface circuitry 1220. The input device(s) 1222 permit(s) a user to enter data and/or commands into the processor circuitry 1212. The input device(s) 1222 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1224 are also connected to the interface circuitry 1220 of the illustrated example. The output devices 1224 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1220 of the illustrated example, thus, typically includes a graphics driver card, a graphics driver chip, and/or graphics processor circuitry such as a GPU.

The interface circuitry 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1226. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1200 of the illustrated example also includes one or more mass storage devices 1228 to store software and/or data. Examples of such mass storage devices 1228 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 1232, which may be implemented by the machine readable instructions of FIGS. 7-11, may be stored in the mass storage device 1228, in the volatile memory 1214, in the non-volatile memory 1216, and/or on a removable non-transitory computer readable storage medium such as a CD or DVD.

FIG. 13 is a block diagram of an example implementation of the processor circuitry 1212 of FIG. 12. In this example, the processor circuitry 1212 of FIG. 12 is implemented by a microprocessor 1300. For example, the microprocessor 1300 may implement multi-core hardware circuitry such as a CPU, a DSP, a GPU, an XPU, etc. Although it may include any number of example cores 1302 (e.g., 1 core), the microprocessor 1300 of this example is a multi-core semiconductor device including N cores. The cores 1302 of the microprocessor 1300 may operate independently or may cooperate to execute machine readable instructions. For example, machine code corresponding to a firmware program, an embedded software program, or a software program may be executed by one of the cores 1302 or may be executed by multiple ones of the cores 1302 at the same or different times. In some examples, the machine code corresponding to the firmware program, the embedded software program, or the software program is split into threads and executed in parallel by two or more of the cores 1302. The software program may correspond to a portion or all of the machine readable instructions and/or operations represented by the flowcharts of FIGS. 7-11.

The cores 1302 may communicate by an example bus 1304. In some examples, the bus 1304 may implement a communication bus to effectuate communication associated with one(s) of the cores 1302. For example, the bus 1304 may implement at least one of an Inter-Integrated Circuit (I2C) bus, a Serial Peripheral Interface (SPI) bus, a PCI bus, or a PCIe bus. Additionally or alternatively, the bus 1304 may implement any other type of computing or electrical bus. The cores 1302 may obtain data, instructions, and/or signals from one or more external devices by example interface circuitry 1306. The cores 1302 may output data, instructions, and/or signals to the one or more external devices by the interface circuitry 1306. Although the cores 1302 of this example include example local memory 1320 (e.g., Level 1 (L1) cache that may be split into an L1 data cache and an L1 instruction cache), the microprocessor 1300 also includes example shared memory 1310 that may be shared by the cores (e.g., Level 2 (L2_cache)) for high-speed access to data and/or instructions. Data and/or instructions may be transferred (e.g., shared) by writing to and/or reading from the shared memory 1310. The local memory 1320 of each of the cores 1302 and the shared memory 1310 may be part of a hierarchy of storage devices including multiple levels of cache memory and the main memory (e.g., the main memory 1214, 1216 of FIG. 12). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1302 may be referred to as a CPU, DSP, GPU, etc., or any other type of hardware circuitry. Each core 1302 includes control unit circuitry 1314, arithmetic and logic (AL) circuitry (sometimes referred to as an ALU) 1316, a plurality of registers 1318, the L1 cache 1320, and an example bus 1322. Other structures may be present. For example, each core 1302 may include vector unit circuitry, single instruction multiple data (SIMD) unit circuitry, load/store unit (LSU) circuitry, branch/jump unit circuitry, floating-point unit (FPU) circuitry, etc. The control unit circuitry 1314 includes semiconductor-based circuits structured to control (e.g., coordinate) data movement within the corresponding core 1302. The AL circuitry 1316 includes semiconductor-based circuits structured to perform one or more mathematic and/or logic operations on the data within the corresponding core 1302. The AL circuitry 1316 of some examples performs integer based operations. In other examples, the AL circuitry 1316 also performs floating point operations. In yet other examples, the AL circuitry 1316 may include first AL circuitry that performs integer based operations and second AL circuitry that performs floating point operations. In some examples, the AL circuitry 1316 may be referred to as an Arithmetic Logic Unit (ALU). The registers 1318 are semiconductor-based structures to store data and/or instructions such as results of one or more of the operations performed by the AL circuitry 1316 of the corresponding core 1302. For example, the registers 1318 may include vector register(s), SIMD register(s), general purpose register(s), flag register(s), segment register(s), machine specific register(s), instruction pointer register(s), control register(s), debug register(s), memory management register(s), machine check register(s), etc. The registers 1318 may be arranged in a bank as shown in FIG. 13. Alternatively, the registers 1318 may be organized in any other arrangement, format, or structure including distributed throughout the core 1302 to shorten access time. The bus 1322 may implement at least one of an I2C bus, a SPI bus, a PCI bus, or a PCIe bus

Each core 1302 and/or, more generally, the microprocessor 1300 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1300 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 14 is a block diagram of another example implementation of the processor circuitry 1212 of FIG. 12. In this example, the processor circuitry 1212 is implemented by FPGA circuitry 1400. The FPGA circuitry 1400 can be used, for example, to perform operations that could otherwise be performed by the example microprocessor 1300 of FIG. 13 executing corresponding machine readable instructions. However, once configured, the FPGA circuitry 1400 instantiates the machine readable instructions in hardware and, thus, can often execute the operations faster than they could be performed by a general purpose microprocessor executing the corresponding software.

More specifically, in contrast to the microprocessor 1300 of FIG. 13 described above (which is a general purpose device that may be programmed to execute some or all of the machine readable instructions represented by the flowcharts of FIGS. 7-11 but whose interconnections and logic circuitry are fixed once fabricated), the FPGA circuitry 1400 of the example of FIG. 14 includes interconnections and logic circuitry that may be configured and/or interconnected in different ways after fabrication to instantiate, for example, some or all of the machine readable instructions represented by the flowcharts of FIGS. 7-11. In particular, the FPGA 1400 may be thought of as an array of logic gates, interconnections, and switches. The switches can be programmed to change how the logic gates are interconnected by the interconnections, effectively forming one or more dedicated logic circuits (unless and until the FPGA circuitry 1400 is reprogrammed). The configured logic circuits enable the logic gates to cooperate in different ways to perform different operations on data received by input circuitry. Those operations may correspond to some or all of the software represented by the flowcharts of FIGS. 7-11. As such, the FPGA circuitry 1400 may be structured to effectively instantiate some or all of the machine readable instructions of the flowcharts of FIGS. 7-11 as dedicated logic circuits to perform the operations corresponding to those software instructions in a dedicated manner analogous to an ASIC. Therefore, the FPGA circuitry 1400 may perform the operations corresponding to the some or all of the machine readable instructions of FIGS. 7-11 faster than the general purpose microprocessor can execute the same.

In the example of FIG. 14, the FPGA circuitry 1400 is structured to be programmed (and/or reprogrammed one or more times) by an end user by a hardware description language (HDL) such as Verilog. The FPGA circuitry 1400 of FIG. 14, includes example input/output (I/O) circuitry 1402 to obtain and/or output data to/from example configuration circuitry 1404 and/or external hardware (e.g., external hardware circuitry) 1406. For example, the configuration circuitry 1404 may implement interface circuitry that may obtain machine readable instructions to configure the FPGA circuitry 1400, or portion(s) thereof. In some such examples, the configuration circuitry 1404 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1406 may implement the microprocessor 1300 of FIG. 13. The FPGA circuitry 1400 also includes an array of example logic gate circuitry 1408, a plurality of example configurable interconnections 1410, and example storage circuitry 1412. The logic gate circuitry 1408 and interconnections 1410 are configurable to instantiate one or more operations that may correspond to at least some of the machine readable instructions of FIGS. 7-11 and/or other desired operations. The logic gate circuitryl408 shown in FIG. 14 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1408 to enable configuration of the electrical structures and/or the logic gates to form circuits to perform desired operations. The logic gate circuitry 1408 may include other electrical structures such as look-up tables (LUTs), registers (e.g., flip-flops or latches), multiplexers, etc.

The interconnections 1410 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1408 to program desired logic circuits.

The storage circuitry 1412 of the illustrated example is structured to store result(s) of the one or more of the operations performed by corresponding logic gates. The storage circuitry 1412 may be implemented by registers or the like. In the illustrated example, the storage circuitry 1412 is distributed amongst the logic gate circuitry 1408 to facilitate access and increase execution speed.

The example FPGA circuitry 1400 of FIG. 14 also includes example Dedicated Operations Circuitry 1414. In this example, the Dedicated Operations Circuitry 1414 includes special purpose circuitry 1416 that may be invoked to implement commonly used functions to avoid the need to program those functions in the field. Examples of such special purpose circuitry 1416 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1400 may also include example general purpose programmable circuitry 1418 such as an example CPU 1420 and/or an example DSP 1422. Other general purpose programmable circuitry 1418 may additionally or alternatively be present such as a GPU, an XPU, etc., that can be programmed to perform other operations.

Although FIGS. 13 and 14 illustrate two example implementations of the processor circuitry 1212 of FIG. 12, many other approaches are contemplated. For example, as mentioned above, modern FPGA circuitry may include an on-board CPU, such as one or more of the example CPU 1420 of FIG. 14. Therefore, the processor circuitry 1212 of FIG. 12 may additionally be implemented by combining the example microprocessor 1300 of FIG. 13 and the example FPGA circuitry 1400 of FIG. 14. In some such hybrid examples, a first portion of the machine readable instructions represented by any of the flowcharts of FIGS. 7-11 may be executed by one or more of the cores 1302 of FIG. 13 and a second portion of the machine readable instructions represented by any of the flowcharts of FIGS. 7-11 may be executed by the FPGA circuitry 1400 of FIG. 14.

In some examples, the processor circuitry 1212 of FIG. 12 may be in one or more packages. For example, the processor circuitry 1300 of FIG. 13 and/or the FPGA circuitry 1400 of FIG. 14 may be in one or more packages. In some examples, an XPU may be implemented by the processor circuitry 1212 of FIG. 12, which may be in one or more packages. For example, the XPU may include a CPU in one package, a DSP in another package, a GPU in yet another package, and an FPGA in still yet another package.

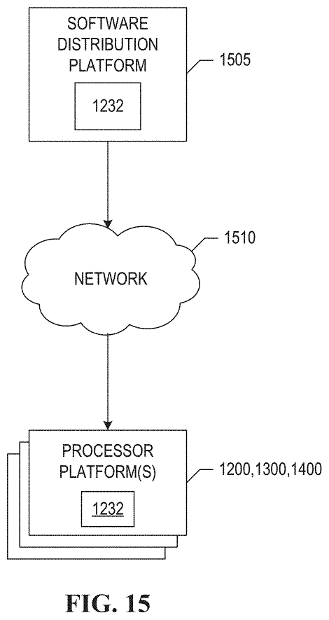

A block diagram illustrating an example software distribution platform 1505 to distribute software such as the example machine readable instructions 1232 of FIG. 12 to hardware devices owned and/or operated by third parties is illustrated in FIG. 15. The example software distribution platform 1505 may be implemented by any computer server, data facility, cloud service, etc., capable of storing and transmitting software to other computing devices. The third parties may be customers of the entity owning and/or operating the software distribution platform 1505. For example, the entity that owns and/or operates the software distribution platform 1505 may be a developer, a seller, and/or a licensor of software such as the example machine readable instructions 1232 of FIG. 12. The third parties may be consumers, users, retailers, OEMs, etc., who purchase and/or license the software for use and/or re-sale and/or sub-licensing. In the illustrated example, the software distribution platform 1505 includes one or more servers and one or more storage devices. The storage devices store the machine readable instructions 1232, which may correspond to the example machine readable instructions 700, 730 of FIGS. 7-11, as described above. The one or more servers of the example software distribution platform 1505 are in communication with a network 1510, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1232 from the software distribution platform 1505. For example, the software, which may correspond to the example machine readable instructions 1232 of FIG. 12, may be downloaded to the example processor platform 1200, which is to execute the machine readable instructions 1232 to implement the sound modification circuitry 105 or portion thereof. In some example, one or more servers of the software distribution platform 1505 periodically offer, transmit, and/or force updates to the software (e.g., the example machine readable instructions 1232 of FIG. 12) to ensure improvements, patches, updates, etc., are distributed and applied to the software at the end user devices.

From the foregoing, it will be appreciated that example systems, methods, apparatus, and articles of manufacture have been disclosed that modify sound of speech in audio signals over machine communication channels. The disclosed systems, methods, apparatus, and articles of manufacture improve the efficiency of using a computing device by reducing latency in audio communications while protecting listeners from toxic, private, and/or confidential words. The disclosed systems, methods, apparatus, and articles of manufacture are accordingly directed to one or more improvement(s) in the operation of a machine such as a computer or other electronic and/or mechanical device.

The examples disclosed herein keep the added latency of a real-time speech stream low, while the speech is modified. In some examples, a substitute word that sounds the same for the beginning part of the word as the keyword but differs in the latter part is used. In some examples, the user or listener hears the first part of the keyword, and the example technology disclosed herein intervenes to substitute the latter part of the keyword so that the user will perceive that only the substitute word has been spoken. One advantage achieved by these examples is that by replacing only the second half or a latter part of the keyword to render the keyword harmless or imperceivable reduces the latency used for analysis and modification of the audio signal because there is no need to wait for the entire word to be transmitted in the audio signal. The delay buffer can be shorter because it is acceptable for user to hear the first part of the keyword, while the second part of the word will be replaced by a benign alternative.

In some examples disclosed herein, the sounds of a latter part of a keyword are suppressed or concealed based on predictions made from the sounds in an initial part of the word and/or context preceding the word and the use of time frequency masking. The initial part of the keyword is used to predict a mask that would suppress or conceal the sound of a possible keyword from being heard. If the speaker actually says a benign or non-keyword, the mask does not block the sounds of the non-keyword and the non-keyword is heard. The mask does not block the sounds of the non-keyword because the spectrum of the non-keyword is different from the mask. However, if the speaker says the keyword, at least a portion of the spectrum of at least a portion of the keyword matches the mask, and the mask suppresses or conceals at least that portion of the keyword. Thus, the listener does not hear the keyword or does not hear the entire keyword. The mask is updated as the audio signal and speech therein progress. By basing the detection of the prior speech and continuously updating the mask for a possible keyword, the latency introduced into the streaming speech channel is reduced dramatically compared to the speech recognition-based suppression algorithms that need to buffer enough speech for the end duration of the longest possible keyword.

Removing toxic speech in social gaming and youth social voice chat networks brings social benefits and safer participation by more people. This results in an increase of total market demand for the underlying technologies including, for example gaming system on chip processors. These examples also have beneficial applications in television (e.g., to conceal explicit language from minors), internet streaming (e.g., to conceal explicit language from minors in songs, videos, etc.), business meetings and/or conference (e.g., to protect copyrighted, secret, and/or other confidential information), and media or other applications (e.g., to protect individual identities and/or otherwise protect privacy).

Apparatus, systems, articles of manufacture, and methods to modify sound of speech in an audio signal are disclosed. Example 1 is an apparatus that includes memory; instructions in the apparatus; and processor circuitry to execute the instructions to: identify a first portion of a keyword in the speech during generation of the speech; determine a waveform to replace a second portion of the keyword; and transform the keyword into a different word by introducing the waveform into the audio signal.

Example 2 includes the apparatus of Example 1, wherein the processor circuitry is to: identify an attribute of the speech; and adjust the waveform based on the attribute.

Example 3 includes the apparatus of Example 2, wherein the attribute is a volume.

Example 4 includes the apparatus of Example 2, wherein the attribute is a vocal register.

Example 5 includes the apparatus of Example 2, wherein the attribute is a prosody.

Example 6 includes the apparatus of Example 2, wherein the attribute is a speaking rate.

Example 7 includes the apparatus of any of Examples 1-6, wherein the processor circuitry is to: identify text of the different word based on the keyword; convert the text to speech; and determine the waveform based on the converted text to speech.

Example 8 includes the apparatus of any of Examples 1-7, wherein the processor circuitry is to: determine a source phoneme sequence of the keyword; identify a target phoneme sequence based on the source phoneme sequence; and build the waveform based on the target phoneme sequence.

Example 9 includes the apparatus of Example 8, wherein the processor circuitry is to implement a neural network to maintain characteristics of a voice speaking the keyword in the speech signal with the different word.

Example 10 includes the apparatus of Example 9, wherein the processor circuitry is to: disentangle characteristics of the voice; learn representations of the speech in the audio signal independent of the source phoneme sequence; and build the waveform based on the learned representations.

Example 11 is an apparatus to modify sound in a speech signal, the apparatus comprising: memory; instructions in the apparatus; and processor circuitry to execute the instructions to: predict a presence of a keyword in the speech during generation of the speech; determine a mask to conceal at least a portion of the keyword; and apply the mask over the speech signal.

Example 12 includes the apparatus of Example 11, wherein the mask is to pass sound of the speech in the audio signal based on an absence of the keyword.

Example 13 includes the apparatus of Examples 11 or 12, wherein the processor circuitry is to adjust the mask based on a rate of speaking in the audio signal.

Example 14 includes the apparatus of any of Examples 11-13, wherein the processor circuitry is to adjust the mask based on a characteristic of a voice in the audio signal.

Example 15 includes the apparatus of any of Examples 11-14, wherein the processor circuitry is to analyze a history of the speech in the audio signal to predict the presence of the keyword.

Example 16 is an apparatus to modify sound of speech in an audio signal, the apparatus comprising: keyword detection circuitry to identify a first portion of a keyword in the speech during generation of the speech signal; waveform identification circuitry to determine a waveform to replace a second portion of the keyword; and waveform generation circuitry to introduce the waveform into the audio signal to transform the keyword into a different word.

Example 17 includes the apparatus of Example 16, further including speech attribute detection circuitry to identify an attribute of the speech in the audio signal, wherein the waveform generation circuitry is to adjust the waveform based on the attribute.

Example 18 includes the apparatus of Example 17, wherein the attribute is a volume.

Example 19 includes the apparatus of Example 17, wherein the attribute is a vocal register.

Example 20 includes the apparatus of Example 17, wherein the attribute is a prosody.

Example 21 includes the apparatus of Example 17, wherein the attribute is a speaking rate.

Example 22 includes the apparatus of any of Examples 16-21, further including: replacement word identification circuitry to identify text of the different word based on the keyword; and text-to-speech conversion circuitry to convert the text to speech, wherein the waveform identification circuitry is to determine the waveform based on the converted text to speech.

Example 23 includes the apparatus of any of Examples 16-22, further including: phoneme sequency analysis circuitry is to: determine a source phoneme sequence of the keyword; and identify a target phoneme sequence based on the source phoneme sequence, wherein the waveform generation circuitry is to build the waveform based on the target phoneme sequence.

Example 24 includes the apparatus of Example 23, further including machine learning training circuitry to implement a neural network to maintain characteristics of a voice speaking the keyword in the audio signal with the different word.

Example 25 includes the apparatus of Example 24, further including encoding circuitry to disentangle characteristics of the voice, wherein the machine learning training circuitry is to learn representations of the speech in the audio signal independent of the source phoneme sequence, and wherein the waveform generation circuitry is to build the waveform based on the learned representations.

Example 26 is an apparatus to modify sound of speech in an audio signal, the apparatus comprising: sound prediction circuitry to predict a presence of a keyword in the speech during generation of the speech; mask identification circuitry to determine a mask to conceal at least a portion of the keyword; and spectral decoding circuitry to apply the mask over the audio signal.

Example 27 includes the apparatus of Example 26, wherein the mask is to pass sound of the speech in the audio signal based on an absence of the keyword.

Example 28 includes the apparatus of Examples 26 or 27, further including mask adaptation circuitry to adjust the mask based on a rate of speaking in the audio signal.

Example 29 includes the apparatus of any of Examples 26-28, further including mask adaptation circuitry to adjust the mask based on a characteristic of a voice in the audio signal.

Example 30 includes the apparatus of any of Examples 26-29, wherein the sound prediction circuitry is to analyze a history of the speech to predict the presence of the keyword.

Example 31 is an apparatus to modify sound of speech in an audio signal, the apparatus comprising: means for identifying a first portion of a keyword in the speech of the audio signal during generation of the speech; means for determining a waveform to replace a second portion of the keyword; and means for introducing the waveform into the audio signal to transform the keyword into a different word.

Example 32 includes the apparatus of Example 31, further including means for identifying an attribute of the speech in the audio signal, wherein the means for introducing the waveform is to adjust the waveform based on the attribute.

Example 33 includes the apparatus of Example 32, wherein the attribute is a volume.

Example 34 includes the apparatus of Example 32, wherein the attribute is a vocal register.

Example 35 includes the apparatus of Example 32, wherein the attribute is a prosody.

Example 36 includes the apparatus of Example 32, wherein the attribute is a speaking rate.

Example 37 includes the apparatus of any of Examples 31-36, further including: means for identifying text of the different word based on the keyword; and means for converting the text to speech, wherein the means for determining the waveform is to determine the waveform based on the converted text to speech.

Example 38 includes the apparatus of any of Examples 31-37, further including: means analyzing phonemes, the phoneme analysis means is to: determine a source phoneme sequence of the keyword; and identify a target phoneme sequence based on the source phoneme sequence, wherein the means for introducing the waveform is to build the waveform based on the target phoneme sequence.

Example 39 includes the apparatus of Example 38, further including means for implementing a neural network to maintain characteristics of a voice speaking the keyword in the speech of the audio signal with the different word.

Example 40 includes the apparatus of Example 39, further including means for disentangling characteristics of the voice, wherein the means for implementing the neural network is to learn representations of the speech in the audio signal independent of the source phoneme sequence, and wherein the means for introducing the waveform is to build the waveform based on the learned representations.

Example 41 is an apparatus to modify sound in a speech signal, the apparatus comprising: means for predicting a presence of a keyword in the speech of the audio signal during generation of the speech; means for determining a mask to conceal at least a portion of the keyword; and means for applying the mask over the audio signal.

Example 42 includes the apparatus of Example 41, wherein the mask is to pass sound of the audio signal based on an absence of the keyword.

Example 43 includes the apparatus of Examples 41 or 42, further including means for adjusting the mask based on a rate of speaking in the audio signal.

Example 44 includes the apparatus of any of Examples 41-43, further including means for adjusting the mask based on a characteristic of a voice in the audio signal.

Example 45 includes the apparatus of any of Examples 41-44, wherein the means for predicting is to analyze a history of the speech in the audio signal to predict the presence of the keyword.

Example 46 is a non-transitory machine readable medium comprising instructions that, when executed, cause one or more processors to at least: identify a first portion of a keyword of speech in an audio signal during generation of the speech; determine a waveform to replace a second portion of the keyword; and transform the keyword into a different word by introducing the waveform into the audio signal.

Example 47 includes the machine readable medium of Example 46, wherein the instructions cause the one or more processors to: identify an attribute of the speech in the audio signal; and adjust the waveform based on the attribute.

Example 48 includes the machine readable medium of Example 47, wherein the attribute is a volume.

Example 49 includes the machine readable medium of Example 47, wherein the attribute is a vocal register.

Example 50 includes the machine readable medium of Example 47, wherein the attribute is a prosody.

Example 51 includes the machine readable medium of Example 47, wherein the attribute is a speaking rate.

Example 52 includes the machine readable medium of any of Examples 46-51, wherein the instructions cause the one or more processors to: identify text of the different word based on the keyword; convert the text to speech; and determine the waveform based on the converted text to speech.

Example 53 includes the machine readable medium of any of Examples 46-52, wherein the instructions cause the one or more processors to: determine a source phoneme sequence of the keyword; identify a target phoneme sequence based on the source phoneme sequence; and build the waveform based on the target phoneme sequence.

Example 54 includes the machine readable medium of Example 53, wherein the instructions cause the one or more processors to implement a neural network to maintain characteristics of a voice speaking the keyword in the audio signal with the different word.

Example 55 includes the machine readable medium of Example 54, wherein the instructions cause the one or more processors to: disentangle characteristics of the voice; learn representations of the speech in the audio signal independent of the source phoneme sequence; and build the waveform based on the learned representations.

Example 56 is a non-transitory machine readable medium comprising instructions that, when executed, cause one or more processors to at least: predict a presence of a keyword in the speech of the audio signal during generation of the speech; determine a mask to conceal at least a portion of the keyword; and apply the mask over the audio signal.

Example 57 includes the machine readable medium of Example 56, wherein the mask is to pass sound of the audio signal based on an absence of the keyword.

Example 58 includes the machine readable medium of Examples 56 or 57, wherein the instructions cause the one or more processors to adjust the mask based on a rate of speaking in the audio signal.

Example 59 includes the machine readable medium of any of Examples 56-58, wherein the instructions cause the one or more processors to adjust the mask based on a characteristic of a voice in the audio signal.

Example 60 includes the machine readable medium of any of Examples 56-59, wherein the instructions cause the one or more processors to analyze a history of the speech in the audio signal to predict the presence of the keyword.

Example 61 is a method to modify sound of speech in an audio signal, the method comprising: identifying, by executing instructions with a processor, a first portion of a keyword in the speech of the audio signal during generation of the speech; determining, by executing instructions with the processor, a waveform to replace a second portion of the keyword; and introducing, by executing instructions with the processor, the waveform into the audio signal to transform the keyword into a different word.

Example 62 includes the method of Example 61, further including: identifying an attribute of the speech in the audio signal; and adjusting the waveform based on the attribute.

Example 63 includes the method of Example 62, wherein the attribute is a volume.

Example 64 includes the method of Example 62, wherein the attribute is a vocal register.

Example 65 includes the method of Example 62, wherein the attribute is a prosody.

Example 66 includes the method of Example 62, wherein the attribute is a speaking rate.

Example 67 includes the method of any of Examples 61-66, further including: identifying text of the different word based on the keyword; converting the text to speech; and determining the waveform based on the converted text to speech.

Example 68 includes the method of any of Examples 61-67, further including: determining a source phoneme sequence of the keyword; identifying a target phoneme sequence based on the source phoneme sequence; and building the waveform based on the target phoneme sequence.

Example 69 includes the method of Example 68, further including implementing a neural network to maintain characteristics of a voice speaking the keyword in the speech of the audio signal with the different word.

Example 70 includes the method of Example 69, further including: disentangling characteristics of the voice; learning representations of the speech in the audio independent of the source phoneme sequence; and building the waveform based on the learned representations.

Example 71 is a method to modify sound of speech in an audio signal, the method comprising: predicting, by executing instructions with a processor, a presence of a keyword in the speech of the audio signal during generation of the speech; determining, by executing instructions with the processor, a mask to conceal at least a portion of the keyword; and applying, by executing instructions with the processor, the mask over the audio signal.

Example 72 includes the method of Example 71, wherein the mask is to pass sound of the speech in the audio signal based on an absence of the keyword.

Example 73 includes the method of Examples 71 or 72, further including adjusting the mask based on a rate of speaking in the audio signal.

Example 74 includes the method of any of Examples 71-73, further including adjusting the mask based on a characteristic of a voice in the audio signal.

Example 75 includes the method of any of Examples 71-74, further including analyzing a history of the speech in the audio signal to predict the presence of the keyword.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

1. An apparatus to modify sound of speech in an audio signal, the apparatus comprising:
memory;
instructions in the apparatus; and
processor circuitry to execute the instructions to:
identify a first portion of a keyword in the speech during generation of the speech;
determine a waveform to replace a second portion of the keyword; and
transform the keyword into a different word by introducing the waveform into the audio signal.

2. The apparatus of claim 1, wherein the processor circuitry is to:
identify an attribute of the speech; and
adjust the waveform based on the attribute.

3. The apparatus of claim 2, wherein the attribute is a volume.

4. The apparatus of claim 2, wherein the attribute is a vocal register.

5. The apparatus of claim 2, wherein the attribute is a prosody.

6. The apparatus of claim 2, wherein the attribute is a speaking rate.

7. The apparatus of claim 1, wherein the processor circuitry is to:
identify text of the different word based on the keyword;
convert the text to speech; and
determine the waveform based on the converted text to speech.

8. The apparatus of claim 1, wherein the processor circuitry is to:
determine a source phoneme sequence of the keyword;
identify a target phoneme sequence based on the source phoneme sequence; and
build the waveform based on the target phoneme sequence.

9. The apparatus of claim 8, wherein the processor circuitry is to implement a neural network to maintain characteristics of a voice speaking the keyword in the speech signal with the different word.

10. The apparatus of claim 9, wherein the processor circuitry is to:
disentangle characteristics of the voice;
learn representations of the speech in the audio signal independent of the source phoneme sequence; and
build the waveform based on the learned representations.

11-45. (canceled)

46. A non-transitory machine readable medium comprising instructions that, when executed, cause one or more processors to at least:
identify a first portion of a keyword of speech in an audio signal during generation of the speech;
determine a waveform to replace a second portion of the keyword; and
transform the keyword into a different word by introducing the waveform into the audio signal.

47. The machine readable medium of claim 46, wherein the instructions cause the one or more processors to:
identify an attribute of the speech in the audio signal; and
adjust the waveform based on the attribute.

48. The machine readable medium of claim 47, wherein the attribute is a volume.

49. The machine readable medium of claim 47, wherein the attribute is a vocal register.

50. The machine readable medium of claim 47, wherein the attribute is a prosody.

51. The machine readable medium of claim 47, wherein the attribute is a speaking rate.

52. The machine readable medium of claim 46, wherein the instructions cause the one or more processors to:
identify text of the different word based on the keyword;
convert the text to speech; and
determine the waveform based on the converted text to speech.

53. The machine readable medium of claim 46, wherein the instructions cause the one or more processors to:
determine a source phoneme sequence of the keyword;
identify a target phoneme sequence based on the source phoneme sequence; and
build the waveform based on the target phoneme sequence.

54. The machine readable medium of claim 53, wherein the instructions cause the one or more processors to implement a neural network to maintain characteristics of a voice speaking the keyword in the audio signal with the different word.

55. The machine readable medium of claim 54, wherein the instructions cause the one or more processors to:
disentangle characteristics of the voice;
learn representations of the speech in the audio signal independent of the source phoneme sequence; and
build the waveform based on the learned representations.

56-75. (canceled)
